(19) United States
(12) Patent Application Publication
(10) Pub. No.: US 2025/0331029 A1
(43) Pub. Date: Oct. 23, 2025

(54) ACCESS METHOD, COMMUNICATION APPARATUS AND MODULE DEVICE

(71) Applicant: SPREADTRUM SEMICONDUCTOR (NANJING) CO., LTD., Nanjing, Jiangsu (CN)

(72) Inventors: Zhenzhu LEI, Nanjing, Jiangsu (CN); Huayu ZHOU, Nanjing, Jiangsu (CN)

(21) Appl. No.: 18/870,611

(22) PCT Filed: May 30, 2023
(86) PCT No.: PCT/CN2023/097106

§ 371 Date: Nov. 29, 2024

(30) Foreign Application Priority Data
May 30, 2022 (CN) 202210603131.3

(51) Int. Cl. H04W 74/0833; H04W 72/21

(52) U.S. Cl. CPC H04W 74/0833; H04W 72/21

(57) ABSTRACT

An access method, a communication apparatus and a module device are provided. The method includes: receiving configuration information from a network device, wherein the configuration information indicates one or more first physical random access channel (PRACH) resources configured to indicate a physical uplink shared channel (PUSCH) repetition, and one or more second PRACH resources configured to indicate a non-PUSCH repetition; transmitting a random access request message to the network device through the first PRACH resource in the case of the PUSCH repetition; and transmitting the random access request message to the network device through the second PRACH resource in the case of the non-PUSCH repetition.

### TECHNICAL FIELD

The present disclosure relates to the field of communication, and in particular to an access method, a communication apparatus and a module device.

### BACKGROUND

With the further evolution of the 5th generation mobile communication (5G) technology, various communication scenarios (such as satellite communication) have an increasingly strong demand for uplink coverage enhancement. Generally speaking, the most direct method for enhancing an uplink coverage is repetition.

In a two-step random access, a terminal device needs to transmit a random access message A (MsgA) to a network device. The MsgA consists of two parts: a random access request message of a physical random access channel (PRACH) and data carried by a physical uplink shared channel (PUSCH). If the uplink coverage enhancement is performed for the two-step random access, the terminal device needs to repeatedly transmit the MsgA. That is, during a random access procedure, the terminal device needs to repeatedly transmit a random access message to the network device multiple times, and repeatedly transmit data information to the network device multiple times. However, upon receipt of a random access request message, the network device cannot determine whether a PUSCH corresponding to the PRACH carrying the random access request message is transmission with repetition or transmission without repetition.

### SUMMARY

The present disclosure provides an access method, a communication apparatus, and a module device, so that the network device may determine whether a PUSCH corresponding to the PRACH carrying the random access request message is transmission with repetition or transmission without repetition.

In a first aspect, the present disclosure provides an access method. The access method includes: receiving configuration information from a network device, where the configuration information indicates one or more first physical random access channel (PRACH) resources and one or more second PRACH resources, the first PRACH resource indicates a physical uplink shared channel (PUSCH) transmission with repetition, and the second PRACH resource indicates a PUSCH transmission without repetition; transmitting a random access request message to the network device through the first PRACH resource in the case of the PUSCH transmission with repetition; and transmitting the random access request message to the network device through the second PRACH resource in the case of the PUSCH transmission without repetition.

Based on the method described in the first aspect, the network device may determine, according to whether the received random access request message is carried on the first PRACH resource or the second PRACH resource, whether the PUSCH corresponding to the PRACH carrying the random access request message is transmission with repetition or transmission without repetition.

In one possible implementation, data information is transmitted to the network device based on a first PUSCH resource corresponding to the first PRACH resource in the case of the PUSCH transmission with repetition, where the first PUSCH resource is determined based on a first mapping ratio and the first PRACH resource, the first mapping ratio is determined based on the number of PRACH repetitions K₁ and the number of PUSCH transmission with repetitions K₂, the first mapping ratio indicates a correspondence between the number of the first PRACH resources and the number of the first PUSCH resources, and K₁ and K₂ are both integers greater than 1; and data information is transmitted to the network device based on a second PUSCH resource corresponding to the second PRACH resource in the case of the PUSCH transmission without repetition, where the second PUSCH resource is determined based on a second mapping ratio and the second PRACH resource, and the second mapping ratio indicates a correspondence between a number of the second PRACH resources and a number of the second PUSCH resources.

In one possible implementation, the first mapping ratio being determined based on the number of PRACH repetitions K₁ and the number of PUSCH transmission with repetitions K₂ specifically includes: the first mapping ratio is determined based on the number of PRACH repetitions K₁, the number of PUSCH transmission with repetitions K₂, the number of valid first PRACH resources in one association pattern period, and the number of valid PUSCH resources in one association pattern period; and the second mapping ratio is determined based on the number of valid second PRACH resources in one association pattern period and the number of the valid PUSCH resources in one association pattern period; where the PUSCH transmission with repetition and the PUSCH transmission without repetition share the same PUSCH resource.

In one possible implementation, the first mapping ratio is a minimum integer greater than or equal to a ratio of a first parameter to a second parameter, where the first parameter is a ratio of the number of the valid first PRACH resources in one association pattern period to K₁, and the second parameter is a ratio of the number of the valid PUSCH resources in one association pattern period to K₂, and the second mapping ratio is a minimum integer greater than or equal to a ratio of the number of the valid second PRACH resources in one association pattern period to the number of the valid PUSCH resources in one association pattern period.

In one possible implementation, the configuration information further indicates one or more first PUSCH resources and one or more second PUSCH resources, the first PUSCH resource is orthogonal to the second PUSCH resource; where the first PUSCH resource indicates the PUSCH transmission with repetition, the second PUSCH resource indicates the PUSCH transmission without repetition, and a PUSCH resource includes a physical uplink shared channel resource occasion (PO) and a demodulation reference signal (DMRS) resource.

In one possible implementation, the first mapping ratio being determined based on the number of PRACH repetitions K₁ and the number of PUSCH repetitions K₂ specifically includes: the first mapping ratio is determined based on the number of PRACH repetitions K₁, the number of PUSCH repetitions K₂, the number of valid first PRACH resources in one association pattern period, and the number of valid first PUSCH resources in one association pattern period; and the second mapping ratio is determined based on the number of valid second PRACH resources in one association pattern period and the number of valid second PUSCH resources in one association pattern period; where a PO in the first PUSCH resource is orthogonal to a PO in the second PUSCH resource.

In one possible implementation, the first mapping ratio is a minimum integer greater than or equal to a ratio of a first parameter to a third parameter, where the first parameter is a ratio of the number of the valid first PRACH resources in one association pattern period to K₁, and the third parameter is a ratio of the number of the valid first PUSCH resources in one association pattern period to K₂; the number of the valid first PUSCH resources in one association pattern period is a product of a number of POs used for a PUSCH transmission and a number of DMRS resources used for the PUSCH transmission with repetition associated with each PO in one association pattern period; the second mapping ratio is a minimum integer greater than or equal to a ratio of the number of the valid second PRACH resources in one association pattern period to the number of the valid second PUSCH resources in one association pattern period; and the number of the valid second PUSCH resources in one association pattern period is a product of a number of the POs used for the PUSCH transmission without repetition and a number of the DMRS resources used for the PUSCH transmission without repetition associated with each PO in one association pattern period.

In one possible implementation, the first mapping ratio being determined based on the number of PRACH repetitions K₁ and the number of PUSCH transmission with repetitions K₂ specifically includes: the first mapping ratio is determined based on the number of PRACH repetitions K₁, the number of PUSCH repetitions K₂, the number of valid first PRACH resources in one association pattern period, and the number of valid first PUSCH resources in one association pattern period; and the second mapping ratio is determined based on the number of valid second PRACH resources in one association pattern period and the number of valid second PUSCH resources in one association pattern period; where a DMRS resource in the first PUSCH resource is orthogonal to a DMRS resource in the second PUSCH resource.

In one possible implementation, the first mapping ratio is a minimum integer greater than or equal to a ratio of a first parameter to a third parameter, where the first parameter is a ratio of the number of the valid first PRACH resources in one association pattern period to K₁, and the third parameter is a ratio of the number of the valid first PUSCH resources in one association pattern period to K₂; the number of the valid first PUSCH resources in one association pattern period is a product of the number of POs used for the PUSCH transmission and the number of DMRS resources used for the PUSCH transmission with repetition associated with each PO in one association pattern period; the second mapping ratio is a minimum integer greater than or equal to a ratio of the number of the valid second PRACH resources in one association pattern period to the number of the valid second PUSCH resources in one association pattern period; and the number of the valid second PUSCH resources in one association pattern period is a product of a number of POs used for the PUSCH transmission without repetition and a number of DMRS resources associated with each PO used for the PUSCH transmission without repetition in one association pattern period.

In one possible implementation, the method further includes: measuring a reference signal received from the network device to obtain a signal measurement result; determining that the PUSCH transmission without repetition and a non-PRACH repetition are to be performed if the signal measurement result of the reference signal is greater than a first threshold; and determining that the PUSCH transmission with repetition and the PRACH repetition are to be performed if the signal measurement result of the reference signal is less than or equal to the first threshold.

In a second aspect, the present application provides an access method. The method includes: transmitting configuration information to a terminal device, where the configuration information indicates one or more first physical random access channel (PRACH) resources and one or more second PRACH resources, the first PRACH resource indicates a physical uplink shared channel (PUSCH) repetition, and the second PRACH resource indicates a PUSCH transmission without repetition; and receiving a random access request message from the terminal device through the first PRACH resource or the second PRACH resource. For the corresponding beneficial effect of the second aspect, reference may be made to the description in the first aspect, which is not repeated in the embodiments of the present disclosure.

In one possible implementation, if the random access request message is received from the terminal device through the first PRACH resource, data information is received from the terminal device on a first PUSCH resource corresponding to the first PRACH resource, where the first PUSCH resource is determined based on a first mapping ratio and the first PRACH resource, the first mapping ratio is determined based on the number of PRACH repetitions K₁ and the number of PUSCH repetitions K₂, the first mapping ratio indicates a correspondence between the number of the first PRACH resources and the number of the first PUSCH resources, and K₁ and K₂ are both integers greater than 1. If the random access request message is received from the terminal device through the second PRACH resource, the data information is received on a second PUSCH resource corresponding to the second PRACH resource, where the second PUSCH resource is determined based on a second mapping ratio and the second PRACH resource, and the second mapping ratio indicates a correspondence between the number of the second PRACH resources and the number of the second PUSCH resources.

In one possible implementation, the first mapping ratio being determined based on the number of PRACH repetitions K and the number of PUSCH repetitions K₂ specifically includes: the first mapping ratio is determined based on the number of PRACH repetitions K₁, the number of PUSCH repetitions K₂, the number of valid first PRACH resources in one association pattern period, and the number of valid PUSCH resources used for a PUSCH transmission in one association pattern period; and the second mapping ratio is determined based on the number of valid second PRACH resources in one association pattern period and the number of the valid PUSCH resources in one association pattern period; where the PUSCH transmission with repetition and the PUSCH transmission without repetition share the same PUSCH resource.

In one possible implementation, the first mapping ratio is a minimum integer greater than or equal to a ratio of a first parameter to a second parameter, where the first parameter is a ratio of the number of the valid first PRACH resources in one association pattern period to K₁, and the second parameter is a ratio of the number of the valid PUSCH resources in one association pattern period to K₂; and the second mapping ratio is a minimum integer greater than or equal to a ratio of the number of the valid second PRACH resources in one association pattern period to the number of the valid PUSCH resources in one association pattern period.

In one possible implementation, the configuration information further indicates one or more first PUSCH resources and one or more second PUSCH resources, the first PUSCH resource is orthogonal to the second PUSCH resource; where the first PUSCH resource indicates the PUSCH transmission with repetition, the second PUSCH resource indicates the PUSCH transmission without repetition, and a PUSCH resource includes a physical uplink shared channel resource occasion (PO) and a demodulation reference signal (DMRS) resource.

In one possible implementation, the first mapping ratio being determined based on the number of PRACH repetitions K₁ and the number of PUSCH repetitions K₂ specifically includes: the first mapping ratio is determined based on the number of PRACH repetitions K₁, the number of PUSCH repetitions K₂, the number of valid first PRACH resources in one association pattern period, and the number of valid first PUSCH resources in one association pattern period; and the second mapping ratio is determined based on the number of valid second PRACH resources in one association pattern period and the number of valid second PUSCH resources in one association pattern period; where a PO in the first PUSCH resource is orthogonal to a PO in the second PUSCH resource.

In one possible implementation, the first mapping ratio is a minimum integer greater than or equal to a ratio of a first parameter to a third parameter, where the first parameter is a ratio of the number of the valid first PRACH resources in one association pattern period to K₁, and the third parameter is a ratio of the number of the valid first PUSCH resources in one association pattern period to K₂; the number of the valid first PUSCH resources in one association pattern period is a product of a number of POs used for a PUSCH transmission and a number of DMRS resources used for the PUSCH transmission with repetition associated with each PO in one association pattern period; the second mapping ratio is a minimum integer greater than or equal to a ratio of the number of the valid second PRACH resources in one association pattern period to the number of the valid second PUSCH resources in one association pattern period; and the number of the valid second PUSCH resources in one association pattern period is a product of a number of the POs used for the PUSCH transmission without repetition and a number of the DMRS resources used for the PUSCH transmission without repetition associated with each PO in one association pattern period.

In one possible implementation, the first mapping ratio being determined based on the number of PRACH repetitions K₁ and the number of Ps K₂ specifically includes: the first mapping ratio is determined based on the number of PRACH repetitions K₁, the number of PUSCH repetitions K₂, the number of valid first PRACH resources in one association pattern period, and the number of valid first PUSCH resources in one association pattern period; and the second mapping ratio is determined based on the number of valid second PRACH resources in one association pattern period and the number of valid second PUSCH resources in one association pattern period; where a DMRS resource in the first PUSCH resource is orthogonal to a DMRS resource in the second PUSCH resource.

In one possible implementation, the first mapping ratio is a minimum integer greater than or equal to a ratio of a first parameter to a third parameter, where the first parameter is a ratio of the number of the valid first PRACH resources in one association pattern period to K₁, and the third parameter is a ratio of the number of the valid first PUSCH resources in one association pattern period to K₂; the number of the valid first PUSCH resources in one association pattern period is a product of the number of POs used for the PUSCH transmission and the number of DMRS resources used for the PUSCH transmission with repetition associated with each PO in one association pattern period; the second mapping ratio is a minimum integer greater than or equal to a ratio of the number of the valid second PRACH resources in one association pattern period to the number of the valid second PUSCH resources in one association pattern period; and the number of the valid second PUSCH resources in one association pattern period is a product of the number of POs used for the PUSCH transmission without repetition and the number of DMRS resources associated with each PO used for the PUSCH transmission without repetition in one association pattern period.

In a third aspect, the present disclosure provides a communication apparatus. The communication apparatus includes a receiving unit and a transmitting unit. The receiving unit is configured to receive configuration information from a network device, where the configuration information indicates one or more first physical random access channel (PRACH) resources and one or more second PRACH resources, the first PRACH resource indicates a physical uplink shared channel (PUSCH) repetition, and the second PRACH resource indicates a PUSCH transmission without repetition; and the transmitting unit is configured to transmit a random access request message to the network device through the first PRACH resource in the case of the PUSCH transmission with repetition, and transmit the random access request message to the network device through the second PRACH resource in the case of the PUSCH transmission without repetition.

In a fourth aspect, the present disclosure provides a communication apparatus. The communication apparatus includes a transmitting unit and a receiving unit. The transmitting unit is configured to transmit configuration information to a terminal device, where the configuration information indicates one or more first physical random access channel (PRACH) resources and one or more second PRACH resources, the first PRACH resource indicates a physical uplink shared channel (PUSCH) repetition, and the second PRACH resource indicates a PUSCH transmission without repetition; and the receiving unit is configured to receive a random access request message from the terminal device through the first PRACH resource or the second PRACH resource.

In a fifth aspect, the present disclosure provides a communication apparatus configured to implement the method described in the first aspect or the second aspect and any possible implementation thereof.

In a sixth aspect, the present disclosure provides a communication apparatus, and the communication apparatus may be chip. The communication apparatus includes a logic circuit and an interface coupled to the logic circuit. The interface is configured to input and/or output code instructions, and the logic circuit is configured to execute the code instructions. The communication apparatus is configured to implement the method described in the first aspect or the second aspect and any possible implementation thereof.

In a seventh aspect, the present disclosure provides a module device. The module device includes a communication module, a power supply module, a storage module, and a chip module. The power supply module is configured to provide electric energy to the module device; the storage module is configured to store data and instructions; the communication module is used for internal communication of the module device, or used for communication between the module device and an external device; and the chip module is configured to implement the method described in the first aspect or the second aspect and any possible implementation thereof.

In an eighth aspect, the present disclosure provides a communication apparatus. The communication apparatus includes a memory and a processor. The memory is configured to store a computer program including program instructions, and the processor is configured to invoke the program instructions to cause the communication apparatus to implement the method described in the first aspect or the second aspect and any possible implementation thereof.

In a ninth aspect, the present disclosure provides a computer-readable storage medium having computer-readable instructions stored therein. The computer-readable instructions, when executed on a communication apparatus, cause the communication apparatus to implement the method described in the first aspect or the second aspect and any possible implementation thereof.

### BRIEF DESCRIPTION OF THE DRAWINGS

FIG. 1 is a schematic diagram of a network architecture provided in the embodiments of the present disclosure.

FIG. 2 is a schematic flow diagram of four-step random access provided in the embodiments of the present disclosure.

FIG. 3 is a schematic flow diagram of two-step random access provided in the embodiments of the present disclosure.

FIG. 4 is a schematic flow diagram of an access method provided in the embodiments of the present disclosure.

FIG. 5 is a schematic diagram of RO configurations provided in the embodiments of the present disclosure.

FIG. 6a is a schematic diagram of a PO configuration provided in the embodiments of the present disclosure.

FIG. 6b is a schematic diagram of another PO configuration provided in the embodiments of the present disclosure.

FIG. 6c is a schematic diagram of another PO configuration provided in the embodiments of the present disclosure.

FIG. 6d is a schematic diagram of another PO configuration provided in the embodiments of the present disclosure.

FIG. 7 is a schematic diagram of a mapping of PRACH resources and PUSCH resources provided in the embodiments of the present disclosure.

FIG. 8 is a schematic diagram of a PO assignment provided in the embodiments of the present disclosure.

FIG. 9 is a schematic flow diagram of two-step random access provided in the embodiments of the present disclosure.

FIG. 10 is a schematic diagram of a communication apparatus provided in the embodiments of the present disclosure.

FIG. 11 is a schematic diagram of a communication apparatus provided in the embodiments of the present disclosure.

FIG. 12 is a schematic diagram of a structure of a chip provided in the embodiments of the present disclosure.

FIG. 13 is a schematic diagram of a structure of a module device provided in the embodiments of the present disclosure.

### DETAILED DESCRIPTION

In the following, the technical solutions in the embodiments of the present disclosure will be clearly and completely described with reference to the accompanying drawings. Obviously, the described embodiments are only a part of the embodiments of the present disclosure, and not all of the embodiments. Based on the embodiments of the present disclosure, all the other embodiments obtained by those of ordinary skills in the art without creative work are within the scope of protection of the present disclosure.

The terms used in the following embodiments of the present disclosure are only for the purpose of describing specific embodiments, and are not intended to be used as limitations to the present disclosure. As used in the specification and appended claims of the present disclosure, the singular expressions “a/an”, “one”, “the”, “the above” and “this” are intended to also include plural expressions, unless the context clearly indicates the contrary. It may also be understood that the term “and/or” used in the present disclosure refers to and includes any or all possible combinations of one or more listed items.

It should be noted that terms “first”, “second”, “third”, etc. in the specification, claims, and the following accompanying drawings of the present disclosure are used to distinguish similar objects, and are not necessarily used to describe a specific order or sequence. It may be understood that the order used in such a manner is interchangeable where appropriate, so that the embodiments of the present disclosure described herein may be implemented in an order other than that illustrated or described herein. In addition, the term “include” and any variation thereof are intended to cover a non-exclusive inclusion, for example, a process, method, system, product, or server including a series of steps or units is not necessarily limited to those steps or units that are clearly listed, but may include other steps or units that are not clearly listed or that are inherent to these processes, methods, products, or devices.

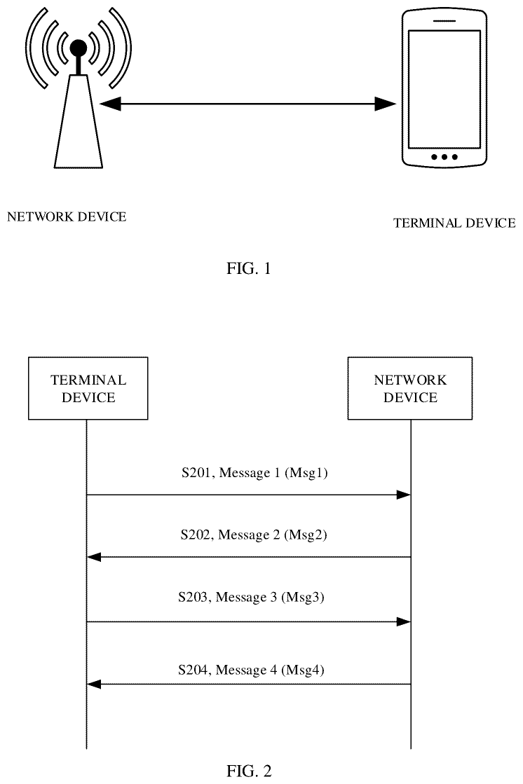

The embodiments of the present disclosure may be applied to a network architecture illustrated in FIG. 1. The network architecture illustrated in FIG. 1 is a network architecture of a wireless communication system, and the network architecture generally includes a terminal device and a network device. The number and form of each device do not constitute a limitation on the embodiments of the present disclosure.

It should be noted that the wireless communication system mentioned in the embodiments of the present disclosure include, but is not limited to: an internet of things (IoT) system, a long term evolution (LTE) system, a 5^{th}-generation mobile communication technology (5G) system, a new radio (NR) system, a 6^{th}-generation mobile communication technology (6G) system, and a future mobile communication system.

The terminal device in the embodiments of the present disclosure is a device with a wireless communication function, and may be referred to as a terminal, user equipment (UE), a mobile station (MS), a mobile terminal (MT), an access terminal device, a vehicle-mounted terminal device, an industrial control terminal device, a UE unit, a UE station, a mobile platform, a remote station, a remote terminal device, a mobile device, a UE terminal device, a wireless communication device, a UE agent, or a UE apparatus.

The terminal device may be fixed or mobile. It should be noted that the terminal device may support at least one wireless communication technology, such as LTE and NR. For example, the terminal device may be a mobile phone, a pad, a desktop computer, a laptop computer, an all-in-one computer, a vehicle-mounted terminal, a virtual reality (VR) terminal device, an augmented reality (AR) terminal device, a wireless terminal in an industrial control, a wireless terminal in a self-driving, a wireless terminal in a remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device with a wireless communication function, a computing device or another processing device connected to a wireless modem, a wearable device, a terminal in a future mobile communication network, or a terminal in a future evolved public land mobile network (PLMN). In some embodiments of the present disclosure, the terminal device may also be an apparatus with a transmitting and receiving function, such as a chip system, where the chip system may include a chip, and may also include other discrete devices, which is not limited in the embodiments of the present disclosure.

In the embodiments of the present disclosure, the network device is a device that provides a wireless communication function for the terminal, and may also be referred to as a radio access network (RAN) device or an access network element, etc. The network device may support at least one wireless communication technology, such as LTE and NR. Exemplarily, the network device includes, but is not limited to: a next generation node B (gNB) in 5G, an evolved node B (eNB), a radio network controller (RNC), a node B (NB), a base station controller (BSC), a base transceiver station (BTS), a home base station (e.g., a home evolved node B or a home node B (HNB)), a baseband unit (BBU), a transmitting and receiving point (TRP), a transmitting point (TP), a mobile switching center, etc. The network device may also be a wireless controller, a centralized unit (CU), and/or a distributed unit (DU) under a cloud radio access network (CRAN) scenario, or the network device may be a relay station, an access point, a vehicle-mounted device, a wearable device, a network device in a future mobile communication, or a network device in a future evolved PLMN. In some embodiments, the network device may also be an apparatus that provides a wireless communication function for the terminal, such as a chip system. Exemplarily, the chip system may include a chip, and may also include other discrete devices. In some embodiments, the network device may also communicate with an internet protocol (IP) network, such as internet, a private IP network, or another data network.

The network architecture and service scenarios described in the embodiments of the present disclosure are intended to more clearly illustrate the technical solution of the embodiments of the present disclosure, and do not constitute a limitation on the technical solution provided in the embodiments of the present disclosure. Those of ordinary skill in the art may appreciate that with the evolution of the network architecture and the emergence of new service scenarios, the technical solution provided in the embodiments of the present disclosure is also applicable to similar technical problems.

Next, some terms involved in the embodiments of the present disclosure are explained to facilitate understanding by those skilled in the art.

### 1. Random Access (RA)

A random access procedure refers to a procedure from when a terminal device transmits a random access preamble to attempt to access a network to when the terminal establishes a basic signaling connection with the network. Through the random access, the terminal device may enter a connected state from an idle state or inactive state, establish various carriers with the network device, obtain some necessary resources and parameter configurations, and then communicate with the network device.

In a wireless communication system, such as LTE and 5G NR, four-step random access may be adopted for the terminal device, as illustrated in FIG. 2.

S201, a terminal device transmits a random access message 1 (Msg1) to a network device, where a content of the Msg1 is a random access preamble. The terminal device transmits the random access preamble to the network device to perform a random access request, while the network device estimates a transmission delay between the network device and the terminal device by using the random access preamble sent by the terminal device, so that the network device calibrates an uplink timing.

S202, after receiving the Msg1, the network device transmits a random access message 2 (Msg2) to the terminal device. A random access response may include a time alignment (TA), an uplink (UL) grant, a temporary cell radio network temporary identifier (TC-RNTI), a power control, a resource indication of a random access message 3 (Msg3) sent by the terminal device, etc. The Msg2 may also include other information, which is not limited in the embodiments of the present disclosure.

S203, after the terminal device receives the Msg2, if a random access preamble indicated by a sequence number of the random access preamble in the random access response is the same as the random access preamble sent by the terminal device to the network device in step 201, the terminal device considers that the Msg2 is a random access response for the terminal device, and transmits the Msg3 on an uplink channel resource indicated by the Msg2, where the Msg3 may carry a unique user identifier.

S204, after receiving the Msg3 from the terminal device, the network device returns a random access message 4 (Msg4) to the terminal device that has successfully accessed. The network device will carry, in the Msg4, the unique user identifier (ID) in the Msg3 to specify the terminal device that has successfully accessed, while other terminal devices that have not successfully accessed will initiate the random access again.

For the four-step random access, when the terminal device in the idle or inactive state wants to perform an uplink data transmission, it must first complete at least the above four information interactions to enter the connected state. For ultra-reliable and low latency communications (URLLC) services, four information interactions will result in a relatively high latency, which is not conducive to the low latency requirement of URLLC. For massive machine type communications (mMTC) services, since most services are sporadic packets, the terminal device needs to perform a complete four-step random access to enter the connected state every time to transmit data once, and then return to the idle or non-connected state again. This not only has a high latency, but also has a serious signaling overhead.

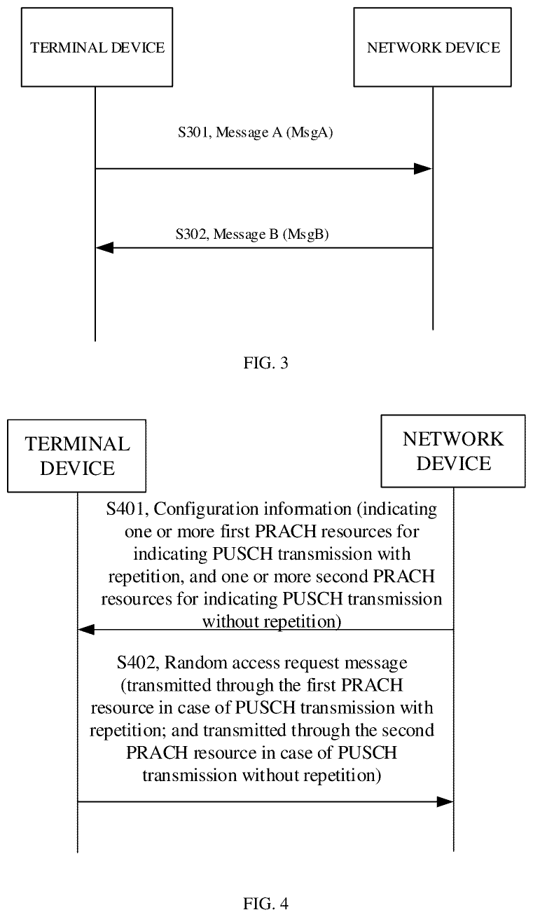

In order to reduce the access latency and signaling overhead, a two-step random access procedure is proposed in the art, as illustrated in FIG. 3.

S301, a terminal device transmits a random access message A (MsgA) to a network device, where the MsgA includes a random access preamble and data.

S302, the network device transmits a random access message B (Msg B) to the terminal device.

Usually, the MsgA represents a first interactive message of the two-step random access, and the MsgA is sent by the terminal device to the network device. The MsgA message includes a MsgA preamble part and a MsgA data part. The preamble part is carried on a MsgA physical random access channel (PRACH) for transmission, and the data part is carried on a MsgA physical uplink shared channel (PUSCH) for transmission. For the convenience of description, without affecting the understanding of the context, the “MsgA preamble part” is referred to as a “preamble”, the “MsgA data part” is referred to as “data information”, the “MsgA PRACH physical channel” is referred to as “PRACH”, and the “MsgA PUSCH physical channel” is referred to as “PUSCH” in the following text.

In the two-step random access procedure, on the one hand, the terminal device transmits the random access preamble and data simultaneously in the first step, so that the latency of uplink data transmission may be greatly reduced. On the other hand, the network device does not need to transmit scheduling information corresponding to the Msg3 to the terminal device, so that the signaling overhead may be reduced.

With the further evolution of the 5G technology, various communication scenarios (such as satellite communication) have an increasingly strong need for uplink coverage enhancement. Generally speaking, the most direct method for enhancing an uplink coverage is repetition. The Msg A includes a random access request message (random access preamble) carried on a PRACH and data information carried on a PUSCH. If the uplink coverage enhancement is performed for the two-step random access, the terminal device needs to repeatedly transmit the Msg A. That is, during random access, the terminal device needs to repeatedly transmit a random access message to the network device multiple times, and repeatedly transmit data information to the network device multiple times. However, upon receipt of a random access request message, the network device cannot determine whether the PUSCH corresponding to the PRACH carrying the random access request message is transmission with repetition (PUSCH repetition for short) or transmission without repetition.

In order to enable the network device to determine whether the PUSCH corresponding to the PRACH carrying the random access request message is transmission with repetition or transmission without repetition, the embodiments of the present disclosure propose an access method, as illustrated in FIG. 4, and the access method mainly includes step S401 to step S402. The method illustrated in FIG. 4 may be performed by a terminal device and a network device. Alternatively, the method illustrated in FIG. 4 may be performed a chip in the terminal device and a chip in the network device. The method of FIG. 4 performed by a terminal device and a network device as an example.

S401: The network device transmits configuration information to the terminal device. Correspondingly, the terminal device receives the configuration information from the network device.

In the embodiments of the present disclosure, the configuration information indicates one or more first PRACH resources and one or more second PRACH resources, the first PRACH resource indicates a PUSCH transmission with repetition, and the second PRACH resource indicates a PUSCH transmission without repetition. In the two-step random access, the MsgA includes a preamble and data information, the preamble is carried on a PRACH for transmission, and the data information is carried on a PUSCH for transmission. The first PRACH resource is orthogonal to the second PRACH resource.

In the embodiments of the present disclosure, there are two manners for transmitting the MsgA, one is MsgA repetition, and the other is non-MsgA repetition.

The MsgA repetition includes PRACH repetition and PUSCH transmission with repetition. Specifically, the PRACH repetition refers to that the terminal device repeatedly transmits a random access preamble to the network device for K₁ times during a random access procedure, and the PUSCH transmission with repetition refers to that the terminal device repeatedly transmits data information to the network device for K₂ times during a random access procedure. K₁ and K₂ are both integers greater than 1.

The non-MsgA repetition includes non-PRACH repetition and PUSCH transmission without repetition. Specifically, the non-PRACH repetition refers to that the terminal device transmits a random access preamble to the network device one time during a random access procedure, and the PUSCH transmission without repetition refers to that the terminal device transmits data information to the network device one time during a random access procedure.

In the embodiments of the present disclosure, one PRACH resource refers to a combination of one PRACH occasion (RO) and one preamble. One RO may correspond to multiple preambles. Usually, one RO corresponds to 64 preambles. A quantitative correspondence between ROs and preambles is not limited in the embodiments of the present disclosure. One PUSCH resource refers to a combination of one PUSCH occasion (PO) and one demodulation reference signal (DMRS) resource. One DMRS resource refers to one DMRS sequence or one DMRS antenna port.

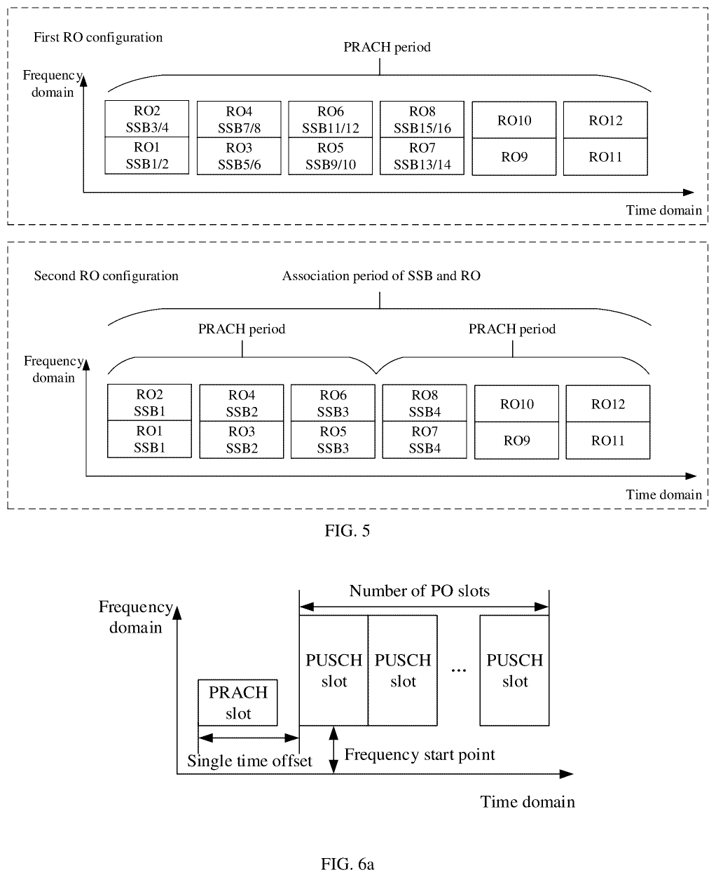

For a RO configuration, FIG. 5 is taken as an example for exemplary illustration. FIG. 5 is a schematic diagram of some RO configurations provided in the embodiments of the present disclosure. In a first RO configuration, the number of synchronization signal and physical broadcast channel (PBCH) blocks (SSBs) is 16, the number of ROs in one PRACH period is 12, the number of ROs multiplexed in frequency is 2, and the number of SSBs associated with each RO is 2. In a second RO configuration, the number of SSBs is 4, the number of ROs in one PRACH period is 12, the number of ROs multiplexed in frequency is 2, and the number of SSBs associated with each RO is ½, that is, one SSB is associated with two ROs.

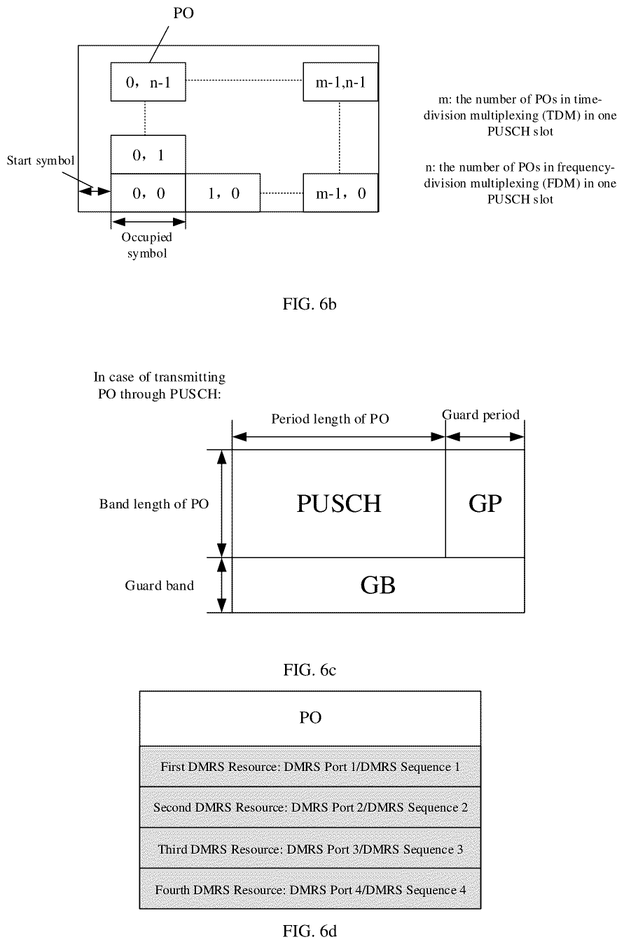

For the PO configuration, FIG. 6a to FIG. 6d are taken as examples for exemplary illustration. In FIG. 6a, the vertical axis represents a frequency domain and the horizontal axis represents a time domain. It can be seen that one PRACH slot and multiple PUSCH slots are included in one time-domain resource. A time interval between a start time of the PRACH slot and a start time of the first PUSCH slot in the time domain is a single time offset, and a frequency domain length from a PUSCH slot to a zero frequency is a frequency start point. FIG. 6b illustrates one PUSCH slot of multiple PUSCH slots in FIG. 6a, and m×n POs are included in the PUSCH slot, where m represents the number of POs in time-division multiplexing (TDM) in one PUSCH slot, and n represents the number of POs in frequency-division multiplexing (FDM) in one PUSCH slot. FIG. 6c is a schematic diagram illustrating transmission of one PO of the multiple POs in FIG. 6b. When transmitting the PO through a PUSCH, a guard period (GP) of a PO and a guard band (GB) of a PO are further included. The GP of a PO and the GB of a PO are used to avoid interference between adjacent POs. FIG. 6d illustrates that one PO may be combined with one DMRS resource. The DMRS resource may refer to one DMRS sequence or one DMRS antenna port.

In order to enable the network device to determine whether the PUSCH corresponding to the PRACH of the received random access request message is transmission with repetition or transmission without repetition, a PRACH resource currently available for transmitting a random access request message is divided into two parts, i.e., a first PRACH resource and a second PRACH resource. Configuration information indicates that the first PRACH resource indicates a PUSCH transmission with repetition, and the second PRACH resource indicates a PUSCH transmission without repetition. The terminal device may select corresponding PRACH resources according to different situations.

One PRACH resource refers to a combination of one preamble and one RO. There are two manners for dividing a PRACH resource.

Manner 1: A preamble is divided into two parts. For example, a preamble used for a random access is divided into two parts, one part is a first preamble used to indicate a PUSCH transmission with repetition, and the other part is a second preamble used to indicate a PUSCH transmission without repetition. The network device may determine whether the PUSCH resource corresponding to the preamble a is transmission with repetition or transmission without repetition, according to whether the received preamble belongs to the first preamble or the second preamble. In this Manner 1, the first PRACH resource and the second PRACH resource may share the same RO, and the network device determines whether the PUSCH is repetition or not according to the preamble in the PRACH resource.

Manner 2: an RO is divided into two parts. For example, an RO used for a random access is divided into two parts, one part is a first RO used to indicate PUSCH transmission with repetition, and the other part is a second RO used to indicate PUSCH transmission without repetition. The network device may determine whether the PUSCH resource corresponding to the RO is transmission with repetition or transmission without repetition according to whether the RO carrying the random access request message belongs to the first RO or the second RO. In this manner, the first PRACH resource and the second PRACH resource may share the same preamble, and the network device determines whether the PUSCH is repetition or not according to the RO in the PRACH resource.

With the method described in the present disclosure, the network device may determine whether the PUSCH corresponding to the PRACH is transmission with repetition or transmission without repetition based on a PRACH of the received random access request message.

In one possible implementation, the terminal device selects a manner for transmitting the MsgA based on a signal measurement result of a reference signal received from the network device. Optionally, the access method further includes the following steps: the terminal device measures the reference signal received from the network device to obtain the signal measurement result. If the signal measurement result of the reference signal is greater than a first threshold, the terminal device determines that the PUSCH transmission without repetition and the non-PRACH repetition are to be performed. If the signal measurement result of the reference signal is less than or equal to the first threshold, the terminal device determines that the PUSCH transmission with repetition and the PRACH repetition are to be performed.

The signal measurement result includes one or more of a reference signal receiving power (RSRP), a reference signal receiving quality (RSRQ), and a signal to interference plus noise ratio (SINR). It should be noted that, in addition to the parameters described above, the signal measurement parameters included in the signal measurement result may include other parameters, which is not limited in the embodiments of the present disclosure. If the signal measurement result of the reference signal is greater than the first threshold, it means that that the current signal of the terminal device is relatively good (exemplarily, the terminal device may be in the central area of the cell), the possibility of packet loss is low, and therefore, PUSCH transmission without repetition may be adopted. If the signal measurement result of the reference signal is less than or equal to the first threshold, it means that the current signal of the terminal device is relatively poor (exemplarily, the terminal device may be in the edge area of the cell), and therefore, PUSCH transmission with repetition may be adopted to improve the success rate of receiving the MsgA from the terminal device by the network device. Based on this implementation, the terminal device may select a manner for transmitting the MsgA that is more suitable for the current situation in different situations.

S402: The terminal device transmits a random access request message to the network device. Correspondingly, the network device receives the random access request message from the terminal device.

In the embodiments of the present disclosure, the terminal device transmits a random access request message to the network device through the first PRACH resource in the case of the PUSCH transmission with repetition. Correspondingly, the network device receives the random access request message from the terminal device through the first PRACH resource. The terminal device transmits a random access request message to the network device through the second PRACH resource in the case of the PUSCH transmission without repetition. Correspondingly, the network device receives the random access request message from the terminal device through the second PRACH resource. The random access request message refers to the preamble part in the MsgA.

The manner for transmitting the random access request message in the random access procedure is described above. The manner for transmitting data information will be described below.

In the embodiments of the present disclosure, after step S402, the method further includes the following.

The terminal device transmits data information to the network device based on a first PUSCH resource corresponding to the first PRACH resource in the case of the PUSCH transmission with repetition. The first PUSCH resource is determined based on a first mapping ratio and the first PRACH resource, the first mapping ratio is determined based on the number of PRACH repetitions K₁ and the number of PUSCH repetitions K₂, the first mapping ratio indicates a correspondence between a number of the first PRACH resources and a number of the first PUSCH resources, and K₁ and K₂ are both integers greater than 1.

The terminal device transmits data information to the network device based on a second PUSCH resource corresponding to the second PRACH resource in the case of the PUSCH transmission without repetition. The second PUSCH resource is determined based on a second mapping ratio and the second PRACH resource, and the second mapping ratio indicates a correspondence between the number of the second PRACH resources and the number of the second PUSCH resources.

In the above two possible implementations, the terminal device needs to determine a corresponding PUSCH resource according to a selected PRACH resource and transmit data information on the determined PUSCH resource. The terminal device determines a corresponding PUSCH resource according to a PRACH resource as follows: the terminal device determines a PUSCH resource corresponding to a currently selected PRACH resource based on a mapping rule and a mapping ratio between PRACH resources and PUSCH resources. The mapping ratio refers to a correspondence between the number of PUSCH resources and the number of PRACH resources. Exemplarily, a mapping ratio of 3 refers to that one PUSCH resource corresponds to three PRACH resources.

In different association pattern periods, the mapping ratio is unchanged, and the mapping ratio is greater than or equal to 1. An association pattern period is a period in which a PRACH occasion and an SSB index pattern appear periodically. The association pattern period is determined by the terminal device according to an uplink and downlink time domain resource configuration of the network and a resource configuration of MsgA. The network device may transmit the uplink and downlink time domain resource configuration and the resource configuration of MsgA to the terminal device through high layer signaling.

The mapping rule between PRACH resources and PUSCH resources are as follows.

Step 1: Each PRACH resource is sorted in the following order.

(1) ROs are arranged in ascending order of a preamble index within each RO.

(2) ROs in FDM are arranged in ascending order of a frequency domain resource index.

(3) ROs in TDM within each PRACH slot are arranged in ascending order of a time domain resource index.

Step 2: Each PUSCH resource is sorted in the following order.

(1) POs in FDM are arranged in ascending order of the frequency domain resource index.

(2) POs are arranged in ascending order of a DMRS index within each PO, regarding the ascending order of a DMRS index, it refers to the ascending order of port numbers and then the ascending order of scrambling sequences.

(3) POs in TDM in each PUSCH slot are arranged in ascending order of the time domain resource index.

(4) An arrangement is performed in ascending order of a PUSCH slot index.

Step 3: L consecutive PRACH resources are mapped to the PUSCH resources based on the mapping ratio L, the sorted PRACH resources and the sorted PUSCH resources.

It can be seen according to the forgoing description that one PRACH resource refers to a combination of one RO and one preamble, and one PUSCH resource refers to a combination of one PO and one DMRS resource. The terminal device determines the physical channel resource used to transmit the MsgA is as follows: first, the terminal device selects an RO and a preamble; then, the terminal device determines the PO and DMRS resource used to transmit a PUSCH through a predefined mapping rule and mapping ratio; and last, the terminal device transmits a random access request message based on the selected RO and preamble, and transmits data information based on the determined PO and DMRS resource.

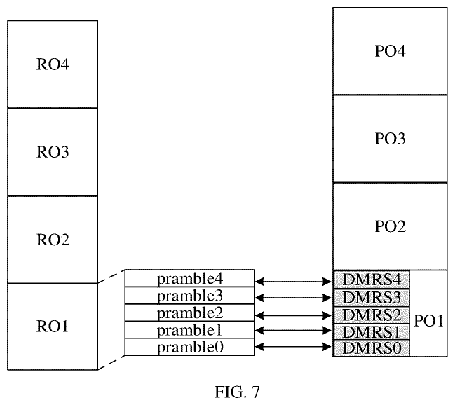

Exemplarily, FIG. 7 is a schematic diagram of a mapping between PRACH resources and PUSCH resources provided in the embodiments of the present disclosure. In FIG. 7, RO1 corresponds to 5 preambles, i.e., preamble0 to preamble4, and PO1 corresponds to 5 DMRS resources, i.e., DMRS0 to DMRS4. According to the above mapping rule, the PRACH resources and the PUSCH are arranged. It is assumed that the mapping ratio between the PRACH resources and the PUSCH resources is 1, then, according to the order of the PRACH resources and the PUSCH resources arranged in step 1 and step 2, one PRACH resource corresponds to one PUSCH resource. Specifically, PRACH resource 1 includes RO1 and preamble0, and the corresponding PUSCH resource 1 includes PO1 and DMRS0. PRACH resource 2 includes RO1 and pramble1, and the corresponding PUSCH resource 2 includes PO1 and DMRS1.

According to the above description, the terminal device and the network device need to determine an associated mapping between PRACH resources and PUSCH resources based on the mapping ratio. Since the number of PRACH resources required for the terminal device to initiate a random access one time in a case of the MsgA repetition is different from the number of PRACH resources required in the case of the non-MsgA repetition, and the number of PUSCH resources required for the terminal device to initiate a random access one time in a case of the MsgA repetition is different from the number of PUSCH resources required in a case of the non-MsgA repetition, the mapping ratio in a case of the MsgA repetition is different from the mapping ratio in a case of the non-MsgA repetition.

In the embodiments of the present disclosure, a first mapping ratio refers to a mapping ratio in a case of the MsgA repetition, and a second mapping ratio refers to a mapping ratio in a case of the non-MsgA repetition. The manner for determining the first mapping ratio and the second mapping ratio will be described below based on whether the PUSCH transmission with repetition and the PUSCH transmission without repetition share the same PUSCH resource.

Case I: The PUSCH transmission with repetition and the PUSCH transmission without repetition share the same PUSCH resource.

The first mapping ratio is determined based on K₁, K₂, the number of valid first PRACH resources in one association pattern period, and the number of valid PUSCH resources in one association pattern period.

The first mapping ratio is a minimum integer greater than or equal to a ratio of a first parameter to a second parameter. The first parameter is a ratio of the number of the valid first PRACH resources within on association pattern period to K₁, and the second parameter is a ratio of the number of the valid PUSCH resources in one association pattern period to K₂.

Specifically, the first mapping ratio is L₁,

$${L}_{1} = ⌈ \frac{( \frac{{T}_{preamble - 1}}{{K}_{1}} )}{( \frac{{T}_{PUSCH}}{{K}_{2}} )} ⌉ ,$$

and T_{pramble-1} is the number of the valid first PRACH resources in one association pattern period, and T_{PUSCH} is the number of the valid PUSCH resources in one association pattern period.

The function symbol ┌ ┐ represents a function that rounds up, is used to return a minimum integer greater than or equal to a specified expression, and may also be represented by ceil. Optionally, the formula may be expressed as

$${L}_{1} = ceil ( \frac{( \frac{{T}_{preamble - 1}}{{K}_{1}} )}{( \frac{{T}_{PUSCH}}{{K}_{2}} )} ) .$$

Subsequent function symbols ┌ ┐ all represent the same meaning, which will not be repeated again in the embodiments of the present disclosure.

In the above formula, T_{pramble-1}=N_{RO}×N_{preamble-1}, N_{RO} is the number of valid ROs in one association pattern period, N_{pramble-1} is the number of preambles used for the PRACH repetition in one association pattern period. T_{PUSCH}=N_{PO}×N_{DMRS}, N_{PO} is the number of valid POs in one association pattern period, and N_{DMRS} is the number of DMRS resources associated with each PO.

The second mapping ratio is determined based on the number of valid second PRACH resources in one association pattern period and the number of the valid PUSCH resources in one association pattern period.

The second mapping ratio is a minimum integer greater than or equal to a ratio of the number of the valid second PRACH resources in one association pattern period to the number of the valid PUSCH resources in one association pattern period.

Specifically, the second mapping ratio is L₂,

$${L}_{2} = ⌈ \frac{{T}_{preamble - 2}}{{T}_{PUSCH}} ⌉ ,$$

and T_{preamble-2} is the number of the valid second PRACH resources in one association pattern period.

In the above formula, T_{pramble-2}=N_{RO}×N_{preamble-2}, and N_{preamble-2} refers to the number of preambles used for the non-PRACH repetition in one association pattern period.

It should be noted that, in the subsequent contents, T_{pramble-1}, T_{preamble-2} and T_{PUSCH} may represent the same meaning, which will not be repeated.

Case II: The PUSCH transmission with repetition and the PUSCH transmission without repetition do not share the same PUSCH resource.

The configuration information in step 401 further indicates one or more first PUSCH resources and one or more second PUSCH resources, and the first PUSCH resource is orthogonal to the second PUSCH resource (which may be also understood as they do not overlap). The first PUSCH resource is used for the PUSCH transmission with repetition, and the second PUSCH resource is used for the PUSCH transmission without repetition.

Since the PUSCH resource is composed of PO and DMRS resource, the first PUSCH resource and the second PUSCH resource may be distinguished by PO or DMRS.

1. The PO in the first PUSCH resource is orthogonal to the PO in the second PUSCH resource.

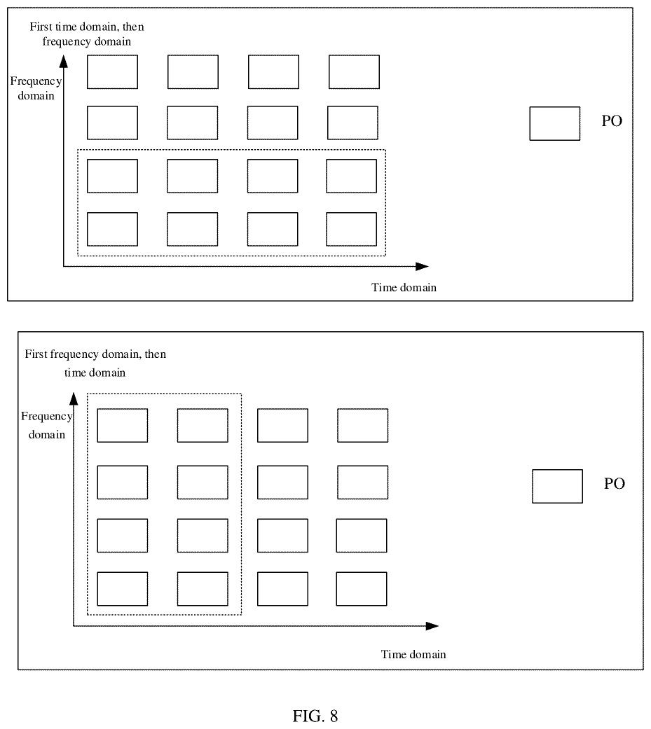

In this case, POs are divided into two parts, one part is used for the PUSCH transmission with repetition, and the other part is used for the PUSCH transmission without repetition. The principle for dividing POs may be first time domain and then frequency domain, or first frequency domain and then time domain. Exemplarily, as illustrated in FIG. 8, it is assumed that one PRACH slot is associated with 16 POs, 8 POs of which are allocated for the PUSCH transmission with repetition, and 8 POs of which are allocated for the PUSCH transmission without repetition. When the division is performed first time domain and then frequency domain, the PO resources in the dotted box are used for the PUSCH transmission with repetition, and the PO resources not in the dotted box are used for the PUSCH transmission without repetition. When the division is performed first frequency domain and then time domain, the PO resources in the dotted box are used for the PUSCH transmission with repetition, and the PO resources not in the dotted box are used for the PUSCH transmission without repetition. It should be noted that, in addition to the principle for dividing POs described above, there may be other principles for dividing POs, which are not limited in the embodiments of the present disclosure.

The first mapping ratio is determined based on K₁, K₂, the number of the valid first PRACH resources in one association pattern period, and the number of the valid first PUSCH resources in one association pattern period.

The first mapping ratio is a minimum integer greater than or equal to a ratio of a first parameter to a third parameter. The first parameter is a ratio of the number of the valid first PRACH resources in one association pattern period to K₁, and the third parameter is a ratio of the number of the valid first PUSCH resources in one association pattern period to K₂. The number of the valid first PUSCH resources in one association pattern period is the number of POs used for the PUSCH transmission and the number of DMRS resources associated with each PO used for the PUSCH transmission with repetition in one association pattern period.

Specifically, the first mapping ratio is L₁,

$${L}_{1} = ⌈ \frac{( \frac{{T}_{preamble - 1}}{{K}_{1}} )}{( \frac{{T}_{PUSCH - 1}}{{K}_{2}} )} ⌉ , {T}_{preamble - 1}$$

is the number of the valid first PRACH resources in one association pattern period, T_{PUSCH-1} is the number of the valid first PUSCH resources in one association pattern period. T_{PUSCH-1}=N_{PO-1}×N_{DMRS}, N_{PO-1} is the number of the POs used for the PUSCH transmission with repetition in one association pattern period, and N_{DMRS} is the number of the DMRS resources associated with each PO.

The second mapping ratio is determined based on the number of the valid second PRACH resources in one association pattern period and the number of the valid second PUSCH resources in one association pattern period.

The second mapping ratio is a minimum integer greater than or equal to a ratio of the number of the valid second PRACH resources in one association pattern period to the number of the valid second PUSCH resources in one association pattern period. The number of the valid second PUSCH resources in one association pattern period is the product of the number of POs used for the PUSCH transmission without repetition and the number of DMRS resources associated with each PO used for the PUSCH transmission without repetition in one association pattern period.

Specifically, the second mapping ratio is L₂,

$${L}_{2} = ⌈ \frac{{T}_{preamble - 2}}{{T}_{PUSCH - 2}} ⌉ , {T}_{preamble - 2}$$

is the number of the valid second PRACH resources in one association pattern period, T_{PUSCH-2} is the number of the valid second PUSCH resources in one association pattern period, T_{PUSCH-2}=N_{PO-2}×N_{DMRS}, and N_{PO-2} is the number of POs used for the PUSCH transmission without repetition in one association pattern period.

In the above formula, the manner for determining T_{preamble-2} is the same as the manner in Case I above, which is not repeated in the embodiments of the present disclosure.

2. The DMRS resource in the first PUSCH resource is orthogonal to the DMRS resource in the second PUSCH resource.

In this case, the DMRS resources corresponding to each PO are divided into two parts, one part is used for the PUSCH transmission with repetition, and the other part is used for the PUSCH transmission without repetition. Exemplarily, it is assumed that one PO corresponds to four DMRS resource indexes, which are respectively DMRS1, DMRS2, DMRS3, and DMRS4. The network configures the DMRS resource indexes respectively corresponding to the PUSCH transmission with repetition and the PUSCH transmission without repetition through high layer signaling (such as system information). For example, through high layer signaling, the network configures the DMRS resource corresponding to the PUSCH transmission with repetition as DMRS1, and configures the DMRS resources corresponding to the PUSCH transmission without repetition as DMRS2, DMRS3, and DMRS4.

The first mapping ratio is determined based on the number of PRACH repetitions K₁, the number of PUSCH repetitions K₂, the number of the valid first PRACH resources in one association pattern period, and the number of the valid first PUSCH resources in one association pattern period.

The first mapping ratio is a minimum integer greater than or equal to a ratio of a first parameter to a third parameter. The first parameter is a ratio of the number of the valid first PRACH resources in one association pattern period to K₁, and the third parameter is a ratio of the number of the valid first PUSCH resources in one association pattern period to K₂. The number of the valid first PUSCH resources in one association pattern period is the number of POs used for the PUSCH transmission and the number of DMRS resources associated with each PO used for the PUSCH transmission with repetition in one association pattern period.

Specifically, the first mapping ratio is L₁,

$${L}_{1} = ⌈ \frac{( \frac{{T}_{preamble - 1}}{{K}_{1}} )}{( \frac{{T}_{PUSCH - 1}}{{K}_{2}} )} ⌉ , {T}_{preamble - 1}$$

is the number of the valid first PRACH resources in one association pattern period, and T_{PUSCH-1} is the number of the valid first PUSCH resources in one association pattern period. T_{PUSCH}-1=N_{PO}×N_{DMRS-1}, N_{PO} is the number of POs used for the PUSCH transmission in one association pattern period, and N_{DMRS-1} is the number of DMRS resources associated with each PO used for the PUSCH transmission with repetition.

The second mapping ratio is determined based on the number of the valid second PRACH resources in one association pattern period and the number of the valid second PUSCH resources in one association pattern period.

The second mapping ratio is a minimum integer greater than or equal to a ratio of the number of the valid second PRACH resources in one association pattern period to the number of the valid second PUSCH resources in one association pattern period. The number of the valid second PUSCH resources in one association pattern period is the product of the number of POs used for the PUSCH transmission without repetition and the number of DMRS resources associated with each PO used for the PUSCH transmission without repetition in one association pattern period.

Specifically, the second mapping ratio is L₂,

$${L}_{2} = ⌈ \frac{{T}_{preamble - 2}}{{T}_{PUSCH - 2}} ⌉ , {T}_{preamble - 2}$$

is the number of the valid second PRACH resources in one association pattern period, and T_{PUSCH-2} is the number of the valid second PUSCH resources in one association pattern period. T_{PUSCH-2}=N_{PO}×N_{DMRS-2}, and N_{DMRS-2} is the number of DMRS resources associated with each PO used for the PUSCH transmission without repetition.

Based on the method described in the present disclosure, the network device may determine whether MsgA is transmitted from a terminal device by transmission with repetition or transmission without repetition, by determining whether the MsgA is carried on the first PRACH resource or the second PRACH resource.

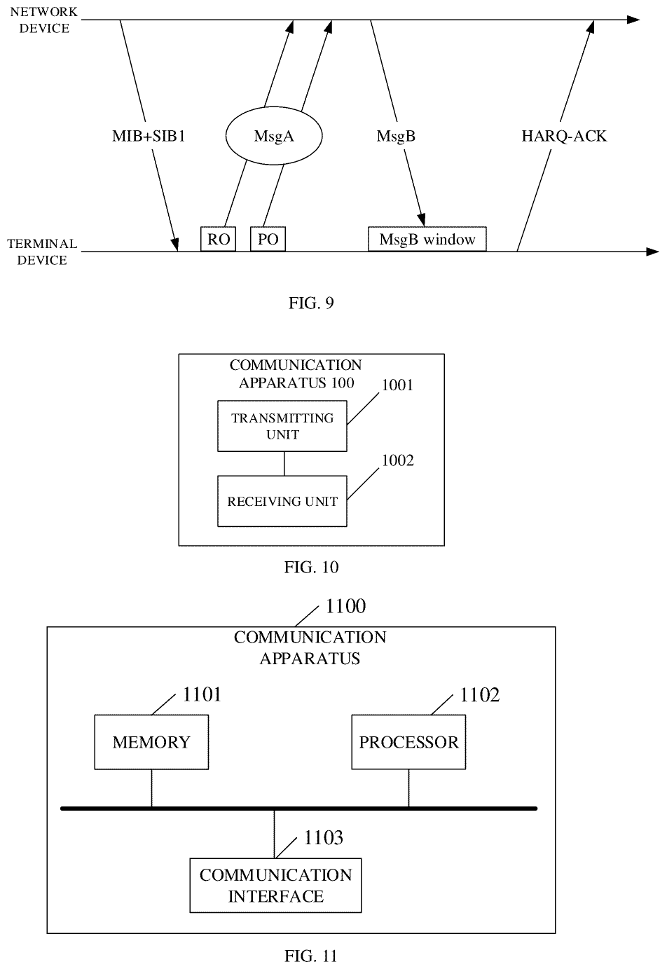

The two-step random access procedure will be described in detail below with reference to FIG. 9.

Step 1: Before transmitting the MsgA to the network device, the terminal device reads a master information block (MIB) and a system information block 1 (SIB1) to complete downlink synchronization. By reading the SIB1, the terminal device may obtain related configurations of ROs, which specifically include a cycle size of the ROs, the number of ROs in one PRACH period, the number of ROs multiplexed on frequency, and the number of synchronization signal blocks (SSBs) associated with each RO.

Step 2: The terminal device measures the SSB, selects an appropriate SSB index, and selects an RO and a preamble according to the determined SSB and a manner for transmitting the MsgA (MsgA repetition or non-MsgA repetition).

The step of selecting, by the terminal device, a manner for transmitting the MsgA includes the following: the terminal device measures a reference signal received from the network device to obtain a signal measurement result; if the signal measurement result of the reference signal is greater than a first threshold, the terminal device determines the PUSCH transmission without repetition and the non-PRACH repetition; and if the signal measurement result of the reference signal is less than or equal to the first threshold, the terminal device determines the PUSCH transmission with repetition and the PRACH repetition.

In the case of PUSCH transmission with repetition, the terminal device selects the RO and the preamble from multiple first PRACH resources indicated in the configuration information; and in the case of the PUSCH transmission without repetition, the terminal device selects the RO and the preamble from multiple second PRACH resources indicated in the configuration information.

Step 3: The terminal device determines the corresponding PO and DMRS resource according to the selected RO and preamble, based on the mapping ratio and the mapping rules.

In the case of PUSCH transmission with repetition, the RO and the preamble of the first PRACH resource selected by the terminal device correspond to the PO and the DMRS resource of the first PUSCH resource; and in the case of the PUSCH transmission without repetition, the RO and the preamble of the second PRACH resource selected by the terminal device correspond to the PO and the DMRS resource of the second PUSCH resource.

Step 4: The terminal device transmits the MsgA based on the determined RO and preamble, the PO and the DMRS resource.

Step 5: After successfully receiving the MsgA transmitted by the terminal device, the network device carries a success random access response (successRAR) corresponding to the terminal device through the MsgB. The successRAR indicates a physical uplink control channel (PUCCH) resource available to the terminal device.

Step 6: The terminal device transmits a hybrid automatic repeat request-acknowledge (HARQ-ACK) message to the network device based on the PUCCH resource indicated by the successRAR.

Referring to FIG. 10, FIG. 10 is a schematic diagram of a structure of a communication apparatus provided in the embodiments of the present disclosure. Specifically, as illustrated in FIG. 10, the communication apparatus 100 includes a transmitting unit 1001 and a receiving unit 1002. Specific description will be made below.

In one embodiment, the receiving unit 1002 is configured to receive configuration information from a network device. The configuration information indicates one or more first physical random access channel (PRACH) resources and one or more second PRACH resources, the first PRACH resource indicates a physical uplink shared channel (PUSCH) repetition, and the second PRACH resource indicates a PUSCH transmission without repetition. The transmitting unit 1001 is configured to transmit a random access request message to the network device through the first PRACH resource in the case of the PUSCH transmission with repetition; and the transmitting unit is further configured to transmit the random access request message to the network device through the second PRACH resource in the case of the PUSCH transmission without repetition.

In one possible implementation, data information is transmitted to the network device based on a first PUSCH resource corresponding to the first PRACH resource in the case of the PUSCH transmission with repetition, where the first PUSCH resource is determined based on a first mapping ratio and the first PRACH resource, the first mapping ratio is determined based on the number of PRACH repetitions K₁ and the number of PUSCH repetitions K₂, the first mapping ratio indicates a correspondence between the number of the first PRACH resources and the number of the first PUSCH resources, and K₁ and K₂ are both integers greater than 1; and data information is transmitted to the network device based on a second PUSCH resource corresponding to the second PRACH resource in the case of the PUSCH transmission without repetition, where the second PUSCH resource is determined based on a second mapping ratio and the second PRACH resource, and the second mapping ratio indicates a correspondence between the number of the second PRACH resources and the number of the second PUSCH resources.

In one possible implementation, the first mapping ratio being determined based on the number of PRACH repetitions K₁ and the number of PUSCH repetitions K₂ specifically includes: the first mapping ratio is determined based on the number of PRACH repetitions K₁, the number of PUSCH repetitions K₂, the number of valid first PRACH resources in one association pattern period, and the number of valid PUSCH resources in one association pattern period; and the second mapping ratio is determined based on the number of valid second PRACH resources in one association pattern period and the number of the valid PUSCH resources in one association pattern period; where the PUSCH transmission with repetition and the PUSCH transmission without repetition share the same PUSCH resource.

In one possible implementation, the first mapping ratio is a minimum integer greater than or equal to a ratio of a first parameter to a second parameter, where the first parameter is a ratio of the number of the valid first PRACH resources in one association pattern period to K₁, and the second parameter is a ratio of the number of the valid PUSCH resources in one association pattern period to K₂; and the second mapping ratio is a minimum integer greater than or equal to a ratio of the number of the valid second PRACH resources in one association pattern period to the number of the valid PUSCH resources in one association pattern period.

In one possible implementation, the configuration information further indicates one or more first PUSCH resources and one or more second PUSCH resources, the first PUSCH resource being orthogonal to the second PUSCH resource; where the first PUSCH resource indicates the PUSCH transmission with repetition, the second PUSCH resource indicates the PUSCH transmission without repetition, and a PUSCH resource includes a physical uplink shared channel resource occasion (PO) and a demodulation reference signal (DMRS) resource.

In one possible implementation, the first mapping ratio being based on the number of PRACH repetitions K₁ and the number of PUSCH repetitions K₂ specifically includes: the first mapping ratio is based on the number of PRACH repetitions K₁, the number of PUSCH repetitions K₂, the number of valid first PRACH resources in one association pattern period, and the number of valid first PUSCH resources in one association pattern period; and the second mapping ratio is determined based on the number of valid second PRACH resources in one association pattern period and the number of valid second PUSCH resources in one association pattern period; where a PO in the first PUSCH resource is orthogonal to a PO in the second PUSCH resource.

In one possible implementation, the first mapping ratio is a minimum integer greater than or equal to a ratio of a first parameter to a third parameter, where the first parameter is a ratio of the number of the valid first PRACH resources in one association pattern period to K₁, and the third parameter is a ratio of the number of the valid first PUSCH resources in one association pattern period to K₂; the number of the valid first PUSCH resources in one association pattern period is a product of the number of the POs used for a PUSCH transmission and the number of DMRS resources used for the PUSCH transmission with repetition associated with each PO in one association pattern period; the second mapping ratio is a minimum integer greater than or equal to a ratio of the number of the valid second PRACH resources in one association pattern period to the number of the valid second PUSCH resources in one association pattern period; and the number of the valid second PUSCH resources in one association pattern period is a product of the number of the POs used for the PUSCH transmission without repetition and the number of the DMRS resources used for the PUSCH transmission without repetition associated with each PO in one association pattern period.

In one possible implementation, the first mapping ratio being determined based on the number of PRACH repetitions K₁ and the number of PUSCH repetitions K₂ specifically includes: the first mapping ratio is determined based on the number of PRACH repetitions K₁, the number of PUSCH repetitions K₂, the number of valid first PRACH resources in one association pattern period, and the number of valid first PUSCH resources in one association pattern period; and the second mapping ratio is determined based on the number of valid second PRACH resources in one association pattern period and the number of valid second PUSCH resources in one association pattern period; where a DMRS resource in the first PUSCH resource is orthogonal to a DMRS resource in the second PUSCH resource.

In one possible implementation, the first mapping ratio is a minimum integer greater than or equal to a ratio of a first parameter to a third parameter, where the first parameter is a ratio of the number of the valid first PRACH resources in one association pattern period to K₁, and the third parameter is a ratio of the number of the valid first PUSCH resources in one association pattern period to K₂; the number of the valid first PUSCH resources in one association pattern period is a product of the number of POs used for the PUSCH transmission and the number of DMRS resources used for the PUSCH transmission with repetition associated with each PO in one association pattern period; the second mapping ratio is a minimum integer greater than or equal to a ratio of the number of the valid second PRACH resources in one association pattern period to the number of the valid second PUSCH resources in one association pattern period; and the number of the valid second PUSCH resources in one association pattern period is a product of the number of POs used for the PUSCH transmission without repetition and the number of DMRS resources associated with each PO used for the PUSCH transmission without repetition in one association pattern period.

In one possible implementation, the communication apparatus further includes a measuring unit and a determining unit. The measuring unit is configured to measure a reference signal received from the network device to obtain a signal measurement result. The determining unit is configured to determine the PUSCH transmission without repetition and a non-PRACH repetition if the signal measurement result of the reference signal is greater than a first threshold; and the determining unit is further used to determine the PUSCH transmission with repetition and the PRACH repetition if the signal measurement result of the reference signal is less than or equal to the first threshold.

In another embodiment, the transmitting unit 1001 is configured to transmit configuration information to a terminal device. The configuration information indicates one or more first physical random access channel (PRACH) resources and one or more second PRACH resources, the first PRACH resource indicates a physical uplink shared channel (PUSCH) repetition, and the second PRACH resource indicates a PUSCH transmission without repetition. The receiving unit 1002 is used to receive a random access request message from the terminal device through the first PRACH resource or the second PRACH resource.

In one possible implementation, the receiving unit 1002 is further configured to receive data information from the terminal device on a first PUSCH resource corresponding to the first PRACH resource, if the random access request message is received from the terminal device through the first PRACH resource. The first PUSCH resource is determined based on a first mapping ratio and the first PRACH resource, the first mapping ratio is determined based on the number of PRACH repetitions K₁ and the number of PUSCH repetitions K₂, the first mapping ratio indicates a correspondence between the number of the first PRACH resources and the number of the first PUSCH resources, and K₁ and K₂ are both integers greater than 1. The receiving unit 1002 is further configured to receive the data information on a second PUSCH resource corresponding to the second PRACH resource, if the random access request message is received from the terminal device through the second PRACH resource. The second PUSCH resource is determined based on a second mapping ratio and the second PRACH resource, and the second mapping ratio indicates a correspondence between the number of the second PRACH resources and the number of the second PUSCH resources.

In one possible implementation, the first mapping ratio being determined based on the number of PRACH repetitions K₁ and the number of PUSCH repetitions K₂ specifically includes: the first mapping ratio is determined based on the number of PRACH repetitions K₁, the number of PUSCH repetitions K₂, the number of valid first PRACH resources in one association pattern period, and the number of valid PUSCH resources used for a PUSCH transmission in one association pattern period; and the second mapping ratio is determined based on the number of valid second PRACH resources in one association pattern period and the number of the valid PUSCH resources in one association pattern period; where the PUSCH transmission with repetition and the PUSCH transmission without repetition share the same PUSCH resource.

In one possible implementation, the first mapping ratio is a minimum integer greater than or equal to a ratio of a first parameter to a second parameter, where the first parameter is a ratio of the number of the valid first PRACH resources in one association pattern period to K₁, and the second parameter is a ratio of the number of the valid PUSCH resources in one association pattern period to K₂, and the second mapping ratio is a minimum integer greater than or equal to a ratio of the number of the valid second PRACH resources in one association pattern period to the number of the valid PUSCH resources in one association pattern period.

In one possible implementation, the configuration information further indicates one or more first PUSCH resources and one or more second PUSCH resources, the first PUSCH resource being orthogonal to the second PUSCH resource; where the first PUSCH resource indicates the PUSCH transmission with repetition, the second PUSCH resource indicates the PUSCH transmission without repetition, and a PUSCH resource includes a physical uplink shared channel resource occasion (PO) and a demodulation reference signal (DMRS) resource.

In one possible implementation, the first mapping ratio being determined based on the number of PRACH repetitions K₁ and the number of PUSCH repetitions K₂ specifically includes: the first mapping ratio is determined based on the number of PRACH repetitions K₁, the number of PUSCH repetitions K₂, the number of valid first PRACH resources in one association pattern period, and the number of valid first PUSCH resources in one association pattern period; and determining the second mapping ratio based on the number of valid second PRACH resources in one association pattern period and the number of valid second PUSCH resources in one association pattern period; where a PO in the first PUSCH resource is orthogonal to a PO in the second PUSCH resource.

In one possible implementation, the first mapping ratio is a minimum integer greater than or equal to a ratio of a first parameter to a third parameter, where the first parameter is a ratio of the number of the valid first PRACH resources in one association pattern period to K₁, and the third parameter is a ratio of the number of the valid first PUSCH resources in one association pattern period to K₂; the number of the valid first PUSCH resources in one association pattern period is the number of POs used for a PUSCH transmission and the number of DMRS resources used for the PUSCH transmission with repetition associated with each PO in one association pattern period; the second mapping ratio is a minimum integer greater than or equal to a ratio of the number of the valid second PRACH resources in one association pattern period to the number of the valid second PUSCH resources in one association pattern period; and the number of the valid second PUSCH resources in one association pattern period is a product of the number of the POs used for the PUSCH transmission without repetition and the number of the DMRS resources used for the PUSCH transmission without repetition associated with each PO in one association pattern period.

In one possible implementation, the first mapping ratio being determined based on the number of PRACH repetitions K and the number of PUSCH repetitions K₂ specifically includes: the first mapping ratio is determined based on the number of PRACH repetitions K₁, the number of PUSCH repetitions K₂, the number of valid first PRACH resources in one association pattern period, and the number of valid first PUSCH resources in one association pattern period; and determining the second mapping ratio based on the number of valid second PRACH resources in one association pattern period and the number of valid second PUSCH resources in one association pattern period; where a DMRS resource in the first PUSCH resource is orthogonal to a DMRS resource in the second PUSCH resource.

In one possible implementation, the first mapping ratio is a minimum integer greater than or equal to a ratio of a first parameter to a third parameter, where the first parameter is a ratio of the number of the valid first PRACH resources in one association pattern period to K₁, and the third parameter is a ratio of the number of the valid first PUSCH resources in one association pattern period to K₂; the number of the valid first PUSCH resources in one association pattern period is the number of POs used for the PUSCH transmission and the number of DMRS resources used for the PUSCH transmission with repetition associated with each PO in one association pattern period; the second mapping ratio is a minimum integer greater than or equal to a ratio of the number of the valid second PRACH resources in one association pattern period to the number of the valid second PUSCH resources in one association pattern period; and the number of the valid second PUSCH resources in one association pattern period is a product of the number of POs used for the PUSCH transmission without repetition and the number of DMRS resources associated with each PO used for the PUSCH transmission without repetition in one association pattern period.

Referring to FIG. 11, FIG. 11 is a schematic diagram of a structure of a communication apparatus provided in the embodiments of the present disclosure. The communication apparatus 1100 may include a memory 1101, a processor 1102, and a communication interface 1103. The memory 1101, the processor 1102, and the communication interface 1103 are connected via one or more communication buses. The communication interface 1103 is controlled by the processor 1102 to transmit and receive information. Optionally, the communication apparatus 1100 may be a chip.

The memory 1101 may include a read-only memory and a random access memory, and provides instructions and data to the processor 1102. A portion of the memory 1101 may also include a nonvolatile random access memory.

The communication interface 1103 is used to receive or transmit data.

The processor 1102 may be a central processing unit (CPU), or the processor 1102 may also be another general-purpose processor, a digital signal processor (DSP), an application specific integrated circuit (ASIC), a field-programmable gate array (FPGA), or another programmable logic device, a discrete gate or transistor logic device, a discrete hardware assembly. The general-purpose processor may be a microprocessor, and optionally, the processor 1102 may also be any conventional processor.

The memory 1101 is used to store program instructions.

The processor 1102 is used to invoke the program instructions stored in the memory 1101.

The processor 1102 invokes the program instructions stored in the memory 1101 to cause the communication apparatus 1100 to implement the method implemented by the terminal device or the network device in the above method embodiments.

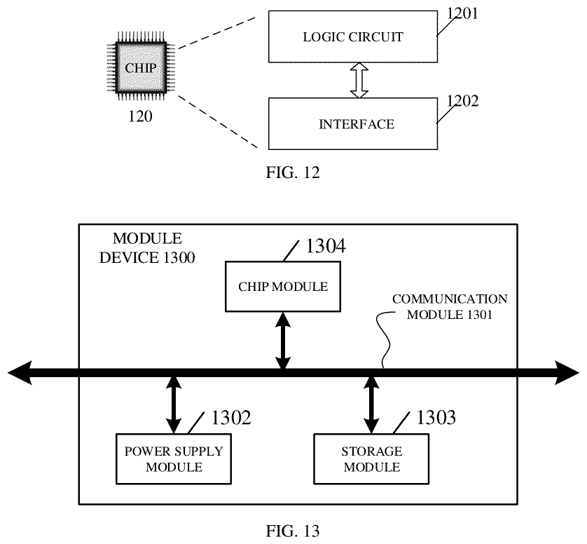

For the case where the communication apparatus may be a chip or a chip system, please refer to the schematic diagram of a chip structure illustrated in FIG. 12. The chip 120 includes a logic circuit 1201 and an interface 1202. The number of the logic circuit 1201 may be one or more, and the number of the interface 1202 may be multiple.

In one embodiment, the logic circuit 1201 is configured to: receive configuration information from a network device, where the configuration information indicates one or more first physical random access channel (PRACH) resources and one or more second PRACH resources, the first PRACH resource indicates a physical uplink shared channel (PUSCH) repetition, and the second PRACH resource indicates a PUSCH transmission without repetition; transmitting a random access request message to the network device through the first PRACH resource in the case of the PUSCH transmission with repetition; and transmit the random access request message to the network device through the second PRACH resource in the case of the PUSCH transmission without repetition.

In one possible implementation, the logic circuit is further configured to transmit data information to the network device based on a first PUSCH resource corresponding to the first PRACH resource in the case of the PUSCH transmission with repetition, where the first PUSCH resource is determined based on a first mapping ratio and the first PRACH resource, the first mapping ratio is determined based on the number of PRACH repetitions K₁ and the number of PUSCH repetitions K₂, the first mapping ratio indicates a correspondence between the number of the first PRACH resources and the number of the first PUSCH resources, and K₁ and K₂ are both integers greater than 1; and transmit data information to the network device based on a second PUSCH resource corresponding to the second PRACH resource in the case of the PUSCH transmission without repetition, where the second PUSCH resource is determined based on a second mapping ratio and the second PRACH resource, and the second mapping ratio indicates a correspondence between the number of the second PRACH resources and the number of the second PUSCH resources.

In one possible implementation, the first mapping ratio being determined based on the number of PRACH repetitions K₁ and the number of PUSCH repetitions K₂ specifically includes: the first mapping ratio is determined based on the number of PRACH repetitions K₁, the number of PUSCH repetitions K₂, the number of valid first PRACH resources in one association pattern period, and the number of valid PUSCH resources in one association pattern period; and the second mapping ratio is determined based on the number of valid second PRACH resources in one association pattern period and the number of the valid PUSCH resources in one association pattern period; where the PUSCH transmission with repetition and the PUSCH transmission without repetition share the same PUSCH resource.

In one possible implementation, the first mapping ratio is a minimum integer greater than or equal to a ratio of a first parameter to a second parameter, where the first parameter is a ratio of the number of the valid first PRACH resources in one association pattern period to K₁, and the second parameter is a ratio of the number of the valid PUSCH resources in one association pattern period to K₂; and the second mapping ratio is a minimum integer greater than or equal to a ratio of the number of the valid second PRACH resources in one association pattern period to the number of the valid PUSCH resources in one association pattern period.

In one possible implementation, the configuration information further indicates one or more first PUSCH resources and one or more second PUSCH resources, the first PUSCH resource being orthogonal to the second PUSCH resource; where the first PUSCH resource indicates the PUSCH transmission with repetition, the second PUSCH resource indicates the PUSCH transmission without repetition, and a PUSCH resource includes a physical uplink shared channel resource occasion (PO) and a demodulation reference signal (DMRS) resource.

In one possible implementation, the first mapping ratio being determined based on the number of PRACH repetitions K₁ and the number of PUSCH repetitions K₂ specifically includes: the first mapping ratio is determined based on the number of PRACH repetitions K₁, the number of PUSCH repetitions K₂, the number of valid first PRACH resources in one association pattern period, and the number of valid first PUSCH resources in one association pattern period; and determining the second mapping ratio based on the number of valid second PRACH resources in one association pattern period and the number of valid second PUSCH resources in one association pattern period; where a PO in the first PUSCH resource is orthogonal to a PO in the second PUSCH resource.

In one possible implementation, the first mapping ratio is a minimum integer greater than or equal to a ratio of a first parameter to a third parameter, where the first parameter is a ratio of the number of the valid first PRACH resources in one association pattern period to K₁, and the third parameter is a ratio of the number of the valid first PUSCH resources in one association pattern period to K₂; the number of the valid first PUSCH resources in one association pattern period is the number of the POs used for a PUSCH transmission and the number of DMRS resources used for the PUSCH transmission with repetition associated with each PO in one association pattern period; the second mapping ratio is a minimum integer greater than or equal to a ratio of the number of the valid second PRACH resources in one association pattern period to the number of the valid second PUSCH resources in one association pattern period; and the number of the valid second PUSCH resources in one association pattern period is a product of the number of the POs used for the PUSCH transmission without repetition and the number of the DMRS resources used for the PUSCH transmission without repetition associated with each PO in one association pattern period.

In one possible implementation, the first mapping ratio being determined based on the number of PRACH repetitions K₁ and the number of PUSCH repetitions K₂ specifically includes: the first mapping ratio is determined based on the number of PRACH repetitions K₁, the number of PUSCH repetitions K₂, the number of valid first PRACH resources in one association pattern period, and the number of valid first PUSCH resources in one association pattern period; and the second mapping ratio is determined based on the number of valid second PRACH resources in one association pattern period and the number of valid second PUSCH resources in one association pattern period; where a DMRS resource in the first PUSCH resource is orthogonal to a DMRS resource in the second PUSCH resource.

In one possible implementation, the first mapping ratio is a minimum integer greater than or equal to a ratio of a first parameter to a third parameter, where the first parameter is a ratio of the number of the valid first PRACH resources in one association pattern period to K₁, and the third parameter is a ratio of the number of the valid first PUSCH resources in one association pattern period to K₂; the number of the valid first PUSCH resources in one association pattern period is the number of POs used for the PUSCH transmission and the number of DMRS resources used for the PUSCH transmission with repetition associated with each PO in one association pattern period; the second mapping ratio is a minimum integer greater than or equal to a ratio of the number of the valid second PRACH resources in one association pattern period to the number of the valid second PUSCH resources in one association pattern period; and the number of the valid second PUSCH resources in one association pattern period is a product of the number of POs used for the PUSCH transmission without repetition and the number of DMRS resources associated with each PO used for the PUSCH transmission without repetition in one association pattern period.

In one possible implementation, the logic circuit 1201 is configured to: measure a reference signal received from the network device to obtain a signal measurement result; determine the PUSCH transmission without repetition and a non-PRACH repetition if the signal measurement result of the reference signal is greater than a first threshold; and determine the PUSCH transmission with repetition and the PRACH repetition if the signal measurement result of the reference signal is less than or equal to the first threshold.

In another embodiment, the logic circuit 1201 is configured to: transmit configuration information to a terminal device, where the configuration information indicates one or more first physical random access channel (PRACH) resources and one or more second PRACH resources, the first PRACH resource indicates a physical uplink shared channel (PUSCH) repetition, and the second PRACH resource indicates a PUSCH transmission without repetition; and receive a random access request message from the terminal device through the first PRACH resource or the second PRACH resource.

In one possible implementation, the logic circuit 1201 is configured to receive data information from the terminal device on a first PUSCH resource corresponding to the first PRACH resource, if receiving the random access request message from the terminal device through the first PRACH resource, where the first PUSCH resource is determined based on a first mapping ratio and the first PRACH resource, the first mapping ratio is determined based on the number of PRACH repetitions K₁ and the number of PUSCH repetitions K₂, the first mapping ratio indicates a correspondence between the number of the first PRACH resources and the number of the first PUSCH resources, and K₁ and K₂ are both integers greater than 1; and the logic circuit 1201 is configured to receive the data information on a second PUSCH resource corresponding to the second PRACH resource, if receiving the random access request message from the terminal device through the second PRACH resource, where the second PUSCH resource is determined based on a second mapping ratio and the second PRACH resource, and the second mapping ratio indicates a correspondence between the number of the second PRACH resources and the number of the second PUSCH resources.

In one possible implementation, the first mapping ratio being determined based on the number of PRACH repetitions K₁ and the number of PUSCH repetitions K₂ specifically includes: the first mapping ratio is determined based on the number of PRACH repetitions K₁, the number of PUSCH repetitions K₂, the number of valid first PRACH resources in one association pattern period, and the number of valid PUSCH resources used for a PUSCH transmission in one association pattern period; and the second mapping ratio is determined based on the number of valid second PRACH resources in one association pattern period and the number of the valid PUSCH resources in one association pattern period; where the PUSCH transmission with repetition and the PUSCH transmission without repetition share the same PUSCH resource.

In one possible implementation, the first mapping ratio is a minimum integer greater than or equal to a ratio of a first parameter to a second parameter, where the first parameter is a ratio of the number of the valid first PRACH resources in one association pattern period to K₁, and the second parameter is a ratio of the number of the valid PUSCH resources in one association pattern period to K₂; and the second mapping ratio is a minimum integer greater than or equal to a ratio of the number of the valid second PRACH resources in one association pattern period to the number of the valid PUSCH resources in one association pattern period.

In one possible implementation, the configuration information further indicates one or more first PUSCH resources and one or more second PUSCH resources, the first PUSCH resource being orthogonal to the second PUSCH resource; where the first PUSCH resource indicates the PUSCH transmission with repetition, the second PUSCH resource indicates the PUSCH transmission without repetition, and a PUSCH resource includes a physical uplink shared channel resource occasion (PO) and a demodulation reference signal (DMRS) resource.

In one possible implementation, the first mapping ratio being determined based on the number of PRACH repetitions K₁ and the number of PUSCH repetitions K₂ specifically includes: determining the first mapping ratio based on the number of PRACH repetitions K₁, the number of PUSCH repetitions K₂, the number of valid first PRACH resources in one association pattern period, and the number of valid first PUSCH resources in one association pattern period; and the second mapping ratio is determined based on the number of valid second PRACH resources in one association pattern period and the number of valid second PUSCH resources in one association pattern period; where a PO in the first PUSCH resource is orthogonal to a PO in the second PUSCH resource.

In one possible implementation, the first mapping ratio is a minimum integer greater than or equal to a ratio of a first parameter to a third parameter, where the first parameter is a ratio of the number of the valid first PRACH resources in one association pattern period to K₁, and the third parameter is a ratio of the number of the valid first PUSCH resources in one association pattern period to K₂; the number of the valid first PUSCH resources in one association pattern period is the number of POs used for a PUSCH transmission and the number of DMRS resources used for the PUSCH transmission with repetition associated with each PO in one association pattern period; the second mapping ratio is a minimum integer greater than or equal to a ratio of the number of the valid second PRACH resources in one association pattern period to the number of the valid second PUSCH resources in one association pattern period; and the number of the valid second PUSCH resources in one association pattern period is a product of the number of the POs used for the PUSCH transmission without repetition and the number of the DMRS resources used for the PUSCH transmission without repetition associated with each PO in one association pattern period.

In one possible implementation, the first mapping ratio being determined based on the number of PRACH repetitions K₁ and the number of PUSCH repetitions K₂ specifically includes: the first mapping ratio is determined based on the number of PRACH repetitions K₁, the number of PUSCH repetitions K₂, the number of valid first PRACH resources in one association pattern period, and the number of valid first PUSCH resources in one association pattern period; and the second mapping ratio is determined based on the number of valid second PRACH resources in one association pattern period and the number of valid second PUSCH resources in one association pattern period; where a DMRS resource in the first PUSCH resource is orthogonal to a DMRS resource in the second PUSCH resource.

In one possible implementation, the first mapping ratio is a minimum integer greater than or equal to a ratio of a first parameter to a third parameter, where the first parameter is a ratio of the number of the valid first PRACH resources in one association pattern period to K₁, and the third parameter is a ratio of the number of the valid first PUSCH resources in one association pattern period to K₂; the number of the valid first PUSCH resources in one association pattern period is the number of POs used for the PUSCH transmission and the number of DMRS resources used for the PUSCH transmission with repetition associated with each PO in one association pattern period; the second mapping ratio is a minimum integer greater than or equal to a ratio of the number of the valid second PRACH resources in one association pattern period to the number of the valid second PUSCH resources in one association pattern period; and the number of the valid second PUSCH resources in one association pattern period is a product of the number of POs used for the PUSCH transmission without repetition and the number of DMRS resources associated with each PO used for the PUSCH transmission without repetition in one association pattern period.

As illustrated in FIG. 13, FIG. 13 is a schematic diagram of a module device provided in the embodiments of the present disclosure. The module device 1300 may perform the related steps of the terminal device or the network device in the above method embodiments. The module device 1300 includes a communication module 1301, a power supply module 1302, a storage module 1303, and a chip module 1304.

The power supply module 1302 is used to provide electric energy to the module device; the storage module 1303 is used to store data and instructions; the communication module 1301 is used for an internal communication of the module device, or used for a communication of the module device with an external device; and the chip module 1304 is used to implement the method implemented by the terminal device or the network device in the above method embodiments.

It should be noted that, for the contents not mentioned in the embodiments corresponding to FIG. 11, FIG. 12 and FIG. 13 and the specific implementations of various steps, please refer to the embodiment illustrated in FIG. 4 and the foregoing contents, which will not be repeated here.

The embodiments of the present disclosure further provide a computer-readable storage medium having instructions stored therein, and when executed on a processor, the instructions cause the method flows in the above method embodiments to be implemented.

The embodiments of the present disclosure further provide a computer program product, and when executed on a processor, the computer program product causes the method flows in the above method embodiments to be implemented.

Various modules/units included in various apparatuses and products described in the above embodiments may be software modules/units or hardware modules/units, or some of the modules/units may be software module/units and some of the modules/units may be hardware module/units. For example, various modules/units included in various apparatuses and products applied to or integrated in a chip may be all embodied in form of hardware such as circuits, or at least some modules/units all be implemented in form of hardware such as circuits, or at least some of the modules/units may be embodied in form of software programs running on a processor integrated in the chip, and the remaining modules/units (if any) may be embodied in form of hardware such as circuits. Various modules/units included in various apparatuses and products applied to or integrated in a chip module may be all embodied in form of hardware such as circuits, different modules/units may be located in the same assembly of the chip module (such as a chip and a circuit module) or in different assemblies, or at least some of the modules/units may be embodied in form of software programs running on a processor integrated in the chip module, and the remaining modules/units (if any) may be embodied in form of hardware such as circuits. Various modules/units included in various apparatuses and products applied to or integrated in a terminal may be all embodied in form of hardware such as circuits, different modules/units may be located in the same assembly of the terminal (such as a chip and a circuit module) or in different assemblies, or at least some of the modules/units may be embodied in form of software programs running on a processor integrated in the terminal, and the remaining modules/units (if any) may be embodied in form of hardware such as circuits.

It should be noted that, for the sake of simple description, all the foregoing method embodiments are expressed as a series of action combinations. However, those skilled in the art should be aware that the present disclosure is not limited by the described order of actions, because certain operations may be performed in other orders or performed simultaneously according to the present disclosure. In addition, those skilled in the art should also be aware that the embodiments described in the specification are all preferred embodiments, and the actions and modules involved are not necessarily required in the present disclosure.

The descriptions of various embodiments provided in the present disclosure may refer to one another, and the descriptions of various embodiments have different focuses. For parts that are not described in detail in a certain embodiment, relevant descriptions of other embodiments may be referred to. For the convenience and conciseness of description, for example, for the functions of various apparatuses and devices provided in the embodiments of the present disclosure and the operations performed, relevant descriptions of the method embodiments in the present disclosure may be referred to. Various method embodiments and various apparatuses embodiments may also refer to, combine with or cite one another.

Finally, it should be noted that the above embodiments are only used to illustrate the technical solutions of the present disclosure, and are not intended to limit them. Although the present disclosure has been illustrated in detail with reference to the foregoing embodiments, those of ordinary skills in the art may understand that modifications may still be made to the technical solutions described in the foregoing embodiments, or equivalent substitutions may be made to some or all of the technical features therein. These modifications or substitutions do not make the substance of the corresponding technical solutions deviate from the scope of the technical solutions of various embodiments in the present disclosure.

1. An access method, comprising:
receiving configuration information from a network device, wherein the configuration information indicates one or more first physical random access channel (PRACH) resources and one or more second PRACH resources, the first PRACH resource indicates a physical uplink shared channel (PUSCH) transmission with repetition, and the second PRACH resource indicates a PUSCH transmission without repetition;
transmitting a random access request message to the network device through the first PRACH resource in the case of the PUSCH transmission with repetition; and
transmitting the random access request message to the network device through the second PRACH resource in the case of the PUSCH transmission without repetition.

2. The method according to claim 1, further comprising:
transmitting data information to the network device based on a first PUSCH resource corresponding to the first PRACH resource in the case of the PUSCH transmission with repetition, wherein the first PUSCH resource is determined based on a first mapping ratio and the first PRACH resource, the first mapping ratio is determined based on a number of PRACH repetitions K₁ and a number of PUSCH repetitions K₂, the first mapping ratio indicates a correspondence between a number of first PRACH resources and a number of first PUSCH resources, and K₁ and K₂ are both integers greater than 1; and
transmitting data information to the network device based on a second PUSCH resource corresponding to the second PRACH resource in the case of the PUSCH transmission without repetition, wherein the second PUSCH resource is determined based on a second mapping ratio and the second PRACH resource, and the second mapping ratio indicates a correspondence between a number of second PRACH resources and a number of second PUSCH resources.

3. The method according to claim 2, wherein the first mapping ratio being determined based on the number of PRACH repetitions K₁ and the number of PUSCH repetitions K₂ comprises:
the first mapping ratio is determined based on the number of PRACH repetitions K₁, the number of PUSCH repetitions K₂, a number of valid first PRACH resources in one association pattern period, and a number of valid PUSCH resources in one association pattern period; and
the second mapping ratio is determined based on a number of valid second PRACH resources in one association pattern period and the number of the valid PUSCH resources in one association pattern period;
wherein the PUSCH transmission with repetition and the PUSCH transmission without repetition share the same PUSCH resource.

4. The method according to claim 3, wherein
the first mapping ratio is a minimum integer greater than or equal to a ratio of a first parameter to a second parameter, wherein the first parameter is a ratio of the number of the valid first PRACH resources in one association pattern period to K₁, and the second parameter is a ratio of the number of the valid PUSCH resources in one association pattern period to K₂; and
the second mapping ratio is a minimum integer greater than or equal to a ratio of the number of the valid second PRACH resources in one association pattern period to the number of the valid PUSCH resources in one association pattern period.

5. The method according to claim 2, wherein the configuration information further indicates one or more first PUSCH resources and one or more second PUSCH resources, the first PUSCH resource being orthogonal to the second PUSCH resource;
wherein the first PUSCH resource is used for the PUSCH transmission with repetition, the second PUSCH resource is used for the PUSCH transmission without repetition, and a PUSCH resource comprises a physical uplink shared channel resource occasion (PO) and a demodulation reference signal (DMRS) resource.

6. The method according to claim 5, wherein the first mapping ratio being determined based on the number of PRACH repetitions K₁ and the number of PUSCH repetitions K₂ comprises:
the first mapping ratio is determined based on the number of PRACH repetitions K₁, the number of PUSCH repetitions K₂, a number of valid first PRACH resources in one association pattern period, and a number of valid first PUSCH resources in one association pattern period; and
the second mapping ratio is determined based on a number of valid second PRACH resources in one association pattern period and a number of valid second PUSCH resources in one association pattern period; wherein
a PO in the first PUSCH resource is orthogonal to a PO in the second PUSCH resource.

7. The method according to claim 6, wherein
the first mapping ratio is a minimum integer greater than or equal to a ratio of a first parameter to a third parameter, wherein the first parameter is a ratio of the number of the valid first PRACH resources in one association pattern period to K₁, and the third parameter is a ratio of the number of the valid first PUSCH resources in one association pattern period to K₂;
the number of the valid first PUSCH resources in one association pattern period is a product of a number of POs used for the PUSCH transmission with repetition and a number of DMRS resources associated with each PO in one association pattern period;
the second mapping ratio is a minimum integer greater than or equal to a ratio of the number of the valid second PRACH resources in one association pattern period to the number of the valid second PUSCH resources in one association pattern period; and
the number of the valid second PUSCH resources in one association pattern period is a product of a number of POs used for the PUSCH transmission without repetition and a number of DMRS resources associated with each PO in one association pattern period.

8. The method according to claim 5, wherein the first mapping ratio being determined based on the number of PRACH repetitions K₁ and the number of PUSCH repetitions K₂ comprises:
the first mapping ratio is determined based on the number of PRACH repetitions K₁, the number of PUSCH repetitions K₂, a number of valid first PRACH resources in one association pattern period, and a number of valid first PUSCH resources in one association pattern period; and
the second mapping ratio is determined based on a number of valid second PRACH resources in one association pattern period and a number of valid second PUSCH resources in one association pattern period; wherein
a DMRS resource in the first PUSCH resource is orthogonal to a DMRS resource in the second PUSCH resource.

9. The method according to claim 8, wherein
the first mapping ratio is a minimum integer greater than or equal to a ratio of a first parameter to a third parameter, wherein the first parameter is a ratio of the number of the valid first PRACH resources in one association pattern period to K₁, and the third parameter is a ratio of the number of the valid first PUSCH resources in one association pattern period to K₂;
the number of the valid first PUSCH resources in one association pattern period is a product of a number of POs used for the PUSCH transmission and a number of DMRS resources used for the PUSCH transmission with repetition associated with each PO in one association pattern period;
the second mapping ratio is a minimum integer greater than or equal to a ratio of the number of the valid second PRACH resources in one association pattern period to the number of the valid second PUSCH resources in one association pattern period; and
the number of the valid second PUSCH resources in one association pattern period is a product of a number of POs used for the PUSCH transmission without repetition and a number of DMRS resources used for the PUSCH transmission without repetition associated with each PO in one association pattern period.

10. The method according to claim 1, further comprising:
measuring a reference signal received from the network device to obtain a signal measurement result;
determining that the PUSCH transmission without repetition and a non-PRACH repetition are to be performed in response to the signal measurement result of the reference signal being greater than a first threshold; and
determining that the PUSCH transmission with repetition and the PRACH repetition are to be performed in response to the signal measurement result of the reference signal being less than or equal to the first threshold.

11. An access method, comprising:
transmitting configuration information to a terminal device, wherein the configuration information indicates one or more first physical random access channel (PRACH) resources and one or more second PRACH resources, the first PRACH resource indicates a physical uplink shared channel (PUSCH) repetition, and the second PRACH resource indicates a PUSCH transmission without repetition; and
receiving a random access request message from the terminal device through the first PRACH resource or the second PRACH resource.

12. The method according to claim 11, further comprising:
receiving data information from the terminal device on a first PUSCH resource corresponding to the first PRACH resource in response to the random access request message being received from the terminal device through the first PRACH resource, wherein the first PUSCH resource is determined based on a first mapping ratio and the first PRACH resource, the first mapping ratio is determined based on the number of PRACH repetitions K₁ and the number of PUSCH repetitions K₂, the first mapping ratio indicates a correspondence between a number of the first PRACH resources and a number of the first PUSCH resources, and K₁ and K₂ are both integers greater than 1; and
receiving the data information on a second PUSCH resource corresponding to the second PRACH resource in response to the random access request message being received from the terminal device through the second PRACH resource, wherein the second PUSCH resource is determined based on a second mapping ratio and the second PRACH resource, and the second mapping ratio indicates a correspondence between a number of the second PRACH resources and a number of the second PUSCH resources.

13. The method according to claim 12, wherein the first mapping ratio being determined based on the number of PRACH repetitions K₁ and the number of PUSCH transmission with repetitions K₂ comprises:
the first mapping ratio is determined based on the number of PRACH repetitions K₁, the number of PUSCH repetitions K₂, a number of valid first PRACH resources in one association pattern period, and a number of valid PUSCH resources used for PUSCH transmission in one association pattern period; and
the second mapping ratio is determined based on a number of valid second PRACH resources in one association pattern period and the number of the valid PUSCH resources in one association pattern period;
wherein the PUSCH transmission with repetition and the PUSCH transmission without repetition share the same PUSCH resource.

14. The method according to claim 13, wherein
the first mapping ratio is a minimum integer greater than or equal to a ratio of a first parameter to a second parameter, wherein the first parameter is a ratio of the number of the valid first PRACH resources in one association pattern period to K₁, and the second parameter is a ratio of the number of the valid PUSCH resources in one association pattern period to K₂; and
the second mapping ratio is a minimum integer greater than or equal to a ratio of the number of the valid second PRACH resources in one association pattern period to the number of the valid PUSCH resources in one association pattern period.

15. The method according to claim 12, wherein the configuration information indicates one or more first PUSCH resources and one or more second PUSCH resources, the first PUSCH resource being orthogonal to the second PUSCH resource;
wherein the first PUSCH resource is used for the PUSCH transmission with repetition, the second PUSCH resource is used for the PUSCH transmission without repetition, and a PUSCH resource comprises a physical uplink shared channel resource occasion (PO) and a demodulation reference signal (DMRS) resource.

16. The method according to claim 15, wherein the first mapping ratio being determined based on the number of PRACH repetitions K₁ and the number of PUSCH repetitions K₂ comprises:
the first mapping ratio is determined based on the number of PRACH repetitions K₁, the number of PUSCH repetitions K₂, a number of valid first PRACH resources in one association pattern period, and a number of valid first PUSCH resources in one association pattern period; and
the second mapping ratio is determined based on a number of valid second PRACH resources in one association pattern period and a number of valid second PUSCH resources in one association pattern period; wherein
a PO in the first PUSCH resource is orthogonal to a PO in the second PUSCH resource.

17. The method according to claim 16, wherein
the first mapping ratio is a minimum integer greater than or equal to a ratio of a first parameter to a third parameter, wherein the first parameter is a ratio of the number of the valid first PRACH resources in one association pattern period to K₁, and the third parameter is a ratio of the number of the valid first PUSCH resources in one association pattern period to K₂;
the number of the valid first PUSCH resources in one association pattern period is a product of a number of POs used for the PUSCH transmission with repetition and a number of DMRS resources associated with each PO in one association pattern period;
the second mapping ratio is a minimum integer greater than or equal to a ratio of the number of the valid second PRACH resources in one association pattern period to the number of the valid second PUSCH resources in one association pattern period; and
the number of the valid second PUSCH resources in one association pattern period is a product of a number of POs used for the PUSCH transmission without repetition and a number of the DMRS resources associated with each PO in one association pattern period.

18. The method according to claim 15, wherein the first mapping ratio being determined based on the number of PRACH repetitions K₁ and the number of PUSCH repetitions K₂ comprises:
the first mapping ratio is determined based on the number of PRACH repetitions K₁, the number of PUSCH repetitions K₂, a number of valid first PRACH resources in one association pattern period, and a number of valid first PUSCH resources in one association pattern period; and
the second mapping ratio is determined based on a number of valid second PRACH resources in one association pattern period and a number of valid second PUSCH resources in one association pattern period; wherein
a DMRS resource in the first PUSCH resource is orthogonal to a DMRS resource in the second PUSCH resource.

19. The method according to claim 18, wherein
the first mapping ratio is a minimum integer greater than or equal to a ratio of a first parameter to a third parameter, wherein the first parameter is a ratio of the number of the valid first PRACH resources in one association pattern period to K₁, and the third parameter is a ratio of the number of the valid first PUSCH resources in one association pattern period to K₂;
the number of the valid first PUSCH resources in one association pattern period is a product of a number of POs used for the PUSCH transmission and a number of DMRS resources used for the PUSCH transmission with repetition associated with each PO in one association pattern period;
the second mapping ratio is a minimum integer greater than or equal to a ratio of the number of the valid second PRACH resources in one association pattern period to the number of the valid second PUSCH resources in one association pattern period; and
the number of the valid second PUSCH resources in one association pattern period is a product of a number of POs used for the PUSCH transmission without repetition and a number of DMRS resources used for the PUSCH transmission without repetition associated with each PO in one association pattern period.

20. A communication apparatus, comprising:
a communication interface;
a processor; and
a memory storing computer readable programs which, when executed by the processor, are operable with the processor to:
receive, through the communication interface, configuration information from a network device, wherein the configuration information indicates one or more first physical random access channel (PRACH) resources and one or more second PRACH resources, the first PRACH resource indicates a physical uplink shared channel (PUSCH) repetition, and the second PRACH resource indicates a PUSCH transmission without repetition; and
transmit, through the communication interface, a random access request message to the network device through the first PRACH resource in the case of the PUSCH transmission with repetition, and transmit the random access request message to the network device through the second PRACH resource in the case of the PUSCH transmission without repetition.

21-27. (canceled)
